(19) United States
(12) Patent Application Publication
(10) Pub. No.: US 2026/0120484 A1
(43) Pub. Date: Apr. 30, 2026

(54) SYSTEM FOR WIRELESS LICENCE PLATE ANALYSIS AND METHOD OF USE THEREOF

(71) Applicant: GENETEC INC., St-Laurent (CA)

(72) Inventors: Danny Roy, Blainville (CA); Louis-Antoine Blais-Morin, Montreal (CA)

(21) Appl. No.: 19/374,058

(22) Filed: Oct. 30, 2025

Related U.S. Application Data
(60) Provisional application No. 63/713,920, filed on Oct. 30, 2024.

(51) Int. Cl. G06V 20/62; G01S 13/08; G06V 20/58

(52) U.S. Cl. CPC G06V 20/625; G01S 13/08; G06V 20/58; G06V 2201/08

(57) ABSTRACT

A system for identifying, in an image of a scene, a target vehicle that includes a wireless license plate transmitting a unique identifier for the target vehicle via an electromagnetic wave signal generated by the wireless licence plate; it has a processor; and memory storing program code that, when executed by the processor, causes the processor to: determine an angle of arrival of the electromagnetic wave signal; receive from an image capture device the image of a scene comprising the target vehicle; detect a plurality of vehicles in the image of the scene; and identify one of the plurality of vehicles as the target vehicle on the basis of the angle of arrival of the electromagnetic wave signal; a method of use thereof.

The present application claims priority from U.S. provisional patent application No. 63/713,920 filed on Oct. 30, 2024, incorporated herein by reference.

### TECHNICAL FIELD

The present disclosure relates to wireless licence plates, and more particularly to gathering vehicle information related to wireless licence plates.

### BACKGROUND

Wireless licence plates are objects located on vehicles that can broadcast a unique identifier, specific to that vehicle, wirelessly, to inquiring nearby antennae or sensors, such as one located on a patrol vehicle. As such, wireless licence plates can provide identification information to an inquiring vehicle, such as a patrol vehicle, that may be in addition to the licence plate number appearing on the physical licence plate for that vehicle obtained following a licence plate read (LPR) event.

The vehicle may have both a physical licence plate and a wireless licence plate, where the unique identifier broadcasted by the wireless licence plate may be distinct from the licence plate number featured on the physical licence plate.

However, due to the wireless nature of the wireless licence plate, there may be a challenge for patrol vehicles regarding obtaining additional information on the vehicle having the wireless licence plate that has broadcast the unique identifier.

### SUMMARY

The systems and methods of the present disclosure relate to obtaining information on a target vehicle associated to a wireless licence plate. The information is derived from an image taken of the vehicle by an image capture device (e.g. a camera), as explained herein.

A broad aspect is a method of identifying, in an image of a scene, a target vehicle that includes a wireless license plate transmitting a unique identifier for the target vehicle via an electromagnetic wave signal generated by the wireless licence plate and received at an antenna system, comprising determining an angle of arrival of the electromagnetic wave signal; receiving from an image capture device the image of the scene comprising the target vehicle; detecting a plurality of vehicles in the image of the scene; and identifying one of the plurality of vehicles as the target vehicle on the basis of the angle of arrival of the electromagnetic wave signal.

In some embodiments, the angle of arrival may include an azimuth angle and an altitude angle.

In some embodiments, the unique identifier may be received and the image of the scene is generated at a same time.

In some embodiments, the method may include calculating a difference in time between a time of reception of the electromagnetic wave signal delivering the unique identifier and a time of reception of the image of the scene; and computing a change in position of the vehicle as a function of the difference in time that is factored when performing the identifying of the one of the plurality of vehicles as the target vehicle on the basis of the angle of arrival of the electromagnetic wave signal.

In some embodiments, the image of the scene may be a colour image.

In some embodiments, the angle of arrival may be determined from readings generated by two or more antenna arrays.

In some embodiments, the method may include determining a travel distance of the electromagnetic wave signal from a position of the target vehicle when the electromagnetic wave signal is generated, and wherein the identifying one of the plurality of vehicles as the target vehicle may be further performed on the basis of the determined travel distance.

In some embodiments, the image capture device may be part of an array of image capture devices, and wherein the receiving, the detecting and the identifying may be performed for more than one image capture device of the array of image capture devices.

In some embodiments, the image capture device may be a 360-degree camera.

In some embodiments, the image of the scene may be a depth image

In some embodiments, the method may include generating and transmitting an interrogation to the wireless licence plate of the target vehicle to receive the unique identifier.

In some embodiments, the unique identifier may be a licence plate number.

In some embodiments, the image of the scene may include virtual images of the target vehicle and one or more noise vehicles, wherein the identifying further may include performing image analysis of the image of the scene using the angle of arrival to identify an object of the target vehicle in the image of the scene and distinguish the object of the target vehicle from the respective object or objects of the one or more noise vehicles appearing in the image of the scene.

In some embodiments, the method may include extracting from the image of the scene a licence plate number of the one of the plurality of vehicles as the target vehicle.

In some embodiments, the method may include comparing the extracted licence plate number to the unique identifier to determine a correspondence between the extracted licence plate number and the unique identifier.

Another broad aspect is a method of identifying a mismatch between a unique identifier generated by a wireless licence plate of a target vehicle received at an antenna system and a licence plate number featured on a physical licence plate for the target vehicle. The method includes receiving the unique identifier for the target vehicle via an electromagnetic wave signal generated by the wireless licence plate; receiving an image of the target vehicle from an image capture device; identifying a license plate for the target vehicle within the image and optically reading from the image a license plate number corresponding to the license plate; and verifying that the license plate number matches the unique identifier and, upon finding a mismatch, outputting a response indicating an occurrence of the mismatch.

In some embodiments, the image may include a plurality of vehicles including the target vehicle, and the method may include determining travel information related to a transmission of the electromagnetic wave signal; and identifying one of the plurality of vehicles as the target vehicle on the basis of the location information, wherein the licence plate number is determined from an object of the target vehicle appearing in the image.

In some embodiments, the travel information may include an angle of arrival.

In some embodiments, the angle of arrival may include an azimuth angle and an altitude angle.

In some embodiments, the travel information may include a time of flight of the electromagnetic wave signal.

In some embodiments, the method may include generating and transmitting an interrogation to the wireless licence plate of the target vehicle to cause a transmission of the unique identifier.

Another broad aspect is a method of determining an absence of a response from a wireless licence plate of a target vehicle for reception at an antenna system. The method includes receiving an image of the target vehicle from an image capture device; identifying a license plate for the target vehicle within the image and optically reading from the image a license plate number corresponding to the license plate; determining if a unique identifier transmitted via an electromagnetic wave signal received from a wireless licence plate corresponds to the licence plate number of the target vehicle; and upon determining an absence of the unique identifier that corresponds to the licence plate number of the target vehicle, generating an indication of the absence of receiving the unique identifier for the target vehicle.

In some embodiments, the method may include generating and transmitting an interrogation to the wireless licence plate of the target vehicle for causing a transmission via the electromagnetic wave signal of the unique identifier.

In some embodiments, the method may include, following the generating an indication of the absence of receiving the unique identifier for the target vehicle, generating and transmitting an alert to an authority.

Another broad aspect is a method of verifying communication from a wireless licence plate associated to a target vehicle. The method includes receiving an image of the target vehicle from an image capture device; identifying a license plate for the target vehicle within the image and optically reading from the image a license plate number corresponding to the license plate; and monitoring for a reception of an electromagnetic wave signal that transmits a unique identifier, and upon determining an absence of reception of the unique identifier following the monitoring based on travel information of the electromagnetic wave signal, generating an indication of the absence of reception of the unique identifier for the target vehicle.

In some embodiments, the method may include, prior to the monitoring, generating and transmitting an interrogation for causing a transmission via the electromagnetic wave signal of the unique identifier by the wireless licence plate.

Another broad aspect is a method of determining a presence of a wireless licence plate for a target vehicle. The method includes receiving an image of the target vehicle from an image capture device; identifying a license plate for the target vehicle within the image and optically reading from the image a license plate number corresponding to the license plate; and performing a search to determine whether a unique identifier for a wireless licence plate corresponds to the licence plate number for the target vehicle.

In some embodiments, the method may include generating and transmitting an interrogation for causing a transmission via the electromagnetic wave signal of the unique identifier by the wireless licence plate.

Another broad aspect is a system for identifying, in an image of a scene, a target vehicle that includes a wireless license plate transmitting a unique identifier for the target vehicle via an electromagnetic wave signal generated by the wireless licence plate and received at an antenna system, including: a processor; and memory storing program code that, when executed by the processor, causes the processor to: determine an angle of arrival of the electromagnetic wave signal; receive from an image capture device the image of the scene comprising the target vehicle; detect a plurality of vehicles in the image of the scene; and identify one of the plurality of vehicles as the target vehicle on the basis of the angle of arrival of the electromagnetic wave signal.

In some embodiments, the angle of arrival may include an azimuth angle and altitude angle.

In some embodiments, the unique identifier may be received and the image of the scene is generated at substantially a same time.

In some embodiments, the program code may further cause the processor to: calculate a difference in time between a time of transmission or of generation of the electromagnetic wave signal delivering the unique identifier and a time of generation or of reception of the image of the scene; and compute a change in position of the vehicle as a function of the difference in time that is factored when performing the identifying of the one of the plurality of vehicles as the target vehicle on the basis of the angle of arrival of the electromagnetic wave signal.

In some embodiments, the image of the scene may be a colour image.

In some embodiments, the angle of arrival may be determined from readings generated by two or more antenna arrays.

In some embodiments, the program code may further cause the processor to determine a travel distance of the electromagnetic wave signal from a position of the target vehicle when the electromagnetic wave signal is generated, and wherein the identifying one of the plurality of vehicles as the target vehicle may be further performed on the basis of the determined travel distance.

In some embodiments, the image capture device may be part of an array of image capture devices, and wherein the receiving, the detecting and the identifying may be performed for more than one image capture device of the array of image capture devices.

In some embodiments, the system further includes the image capture device and wherein the image capture device may be a 360-degree camera.

In some embodiments, the image of the scene may be a depth image.

In some embodiments, the program code may further cause the processor to generate and transmit an interrogation to the wireless licence plate of the target vehicle to receive the unique identifier.

In some embodiments, the unique identifier may be a licence plate number.

In some embodiments, the image of the scene may include virtual images of the target vehicle and one or more noise vehicles, wherein the identifying further may include performing image analysis of the image of the scene using the angle of arrival to identify an object of the target vehicle in the image of the scene and distinguish the object of the target vehicle from the respective object or objects of the one or more noise vehicles appearing in the image of the scene.

In some embodiments, the program code may further cause the processor to extract from the image of the scene a licence plate number of the one of the plurality of vehicles as the target vehicle.

In some embodiments, the program code may further cause the processor to compare the extracted licence plate number to the unique identifier to determine a correspondence between the extracted licence plate number and the unique identifier.

Another broad aspect is a system for identifying a mismatch between a unique identifier generated by a wireless licence plate of a target vehicle received at an antenna system and a licence plate number featured on a physical licence plate for the target vehicle. The system includes a processor; and memory storing program code that, when executed by the processor, causes the processor to: receive the unique identifier for the target vehicle via an electromagnetic wave signal generated by the wireless licence plate; receive an image of the target vehicle from an image capture device; identify a license plate for the target vehicle within the image and optically reading from the image a license plate number corresponding to the license plate; and verify that the license plate number matches the unique identifier and, upon finding a mismatch, outputting a response indicating an occurrence of the mismatch.

In some embodiments, the image may include a plurality of vehicles including the target vehicle, and wherein the program code further causes the processor to: determine travel information related to a transmission of the electromagnetic wave signal; and identify one of the plurality of vehicles as the target vehicle on the basis of the location information, wherein the licence plate number is determined from an object of the target vehicle appearing in the image.

In some embodiments, the travel information may include an angle of arrival.

In some embodiments, the angle of arrival may include an azimuth angle and an altitude angle.

In some embodiments, the travel information may include a time of flight of the electromagnetic wave signal.

In some embodiments, the program code may further cause the processor to generate and transmit an interrogation to the wireless licence plate of the target vehicle to cause a transmission of the unique identifier.

Another broad aspect is a system for determining an absence of a response from a wireless licence plate of a target vehicle for reception at an antenna system. The system includes a processor; and memory storing program code that, when executed by the processor, causes the processor to: receive an image of the target vehicle from an image capture device; identify a license plate for the target vehicle within the image and optically reading from the image a license plate number corresponding to the license plate; determine if a unique identifier transmitted via an electromagnetic wave signal received from a wireless licence plate corresponds to the licence plate number of the target vehicle; and upon determining an absence of the unique identifier that corresponds to the licence plate number of the target vehicle, generate an indication of the absence of receiving the unique identifier for the target vehicle.

In some embodiments, the program code may further cause the processor to generate and transmit an interrogation to the wireless licence plate of the target vehicle for causing a transmission via the electromagnetic wave signal of the unique identifier.

In some embodiments, the program code may further cause the processor to, following the generating an indication of the absence of receiving the unique identifier for the target vehicle, generate and transmit an alert to law enforcement.

Another broad aspect is a system of verifying communication from a wireless licence plate associated to a target vehicle. The system includes a processor; and memory storing program code that, when executed by the processor, causes the processor to: receive an image of the target vehicle from an image capture device; identify a license plate for the target vehicle within the image and optically reading from the image a license plate number corresponding to the license plate; and monitor for a reception of an electromagnetic wave signal that transmits a unique identifier, and upon determining a presence of reception of the unique identifier following the monitoring based on travel information of the electromagnetic wave signal, generating an indication of the absence of reception of the unique identifier for the target vehicle.

In some embodiments, the program code may further cause the processor to, prior to the monitoring, generate and transmit an interrogation for causing a transmission via the electromagnetic wave signal of the unique identifier by the wireless licence plate.

Another broad aspect is a system for determining a presence of a wireless licence plate for a target vehicle, the system including a processor; and memory storing program code that, when executed by the processor, further causes the processor to: receive an image of the target vehicle from an image capture device; identify a license plate for the target vehicle within the image and optically reading from the image a license plate number corresponding to the license plate; and perform a search to determine whether a unique identifier for a wireless licence plate corresponds to the licence plate number for the target vehicle.

In some embodiments, the program code may further cause the processor to generate and transmit an interrogation for causing a transmission via the electromagnetic wave signal of the unique identifier by the wireless licence plate.

Another broad aspect is a non-transitory computer-readable medium having stored thereon program instructions for identifying, in an image of a scene, a target vehicle that includes a wireless license plate transmitting a unique identifier for the target vehicle via an electromagnetic wave signal generated by the wireless licence plate and received at an antenna system, the program instructions executable by a processing unit for: determining an angle of arrival of the electromagnetic wave signal; receiving from an image capture device the image of the scene comprising the target vehicle; detecting a plurality of vehicles in the image of the scene; and identifying one of the plurality of vehicles as the target vehicle on the basis of the angle of arrival of the electromagnetic wave signal.

In some embodiments, the angle of arrival may include an azimuth angle and an altitude angle.

In some embodiments, the unique identifier may be received and the image of the scene is generated at substantially a same time.

In some embodiments, the program instructions may be further executable by the processing unit for: calculating a difference in time between a time of transmission or of generation of the electromagnetic wave signal delivering the unique identifier and a time of generation or of reception of the image of the scene; and computing a change in position of the vehicle as a function of the difference in time that is factored when performing the identifying of the one of the plurality of vehicles as the target vehicle on the basis of the angle of arrival of the electromagnetic wave signal.

In some embodiments, the image of the scene may be a colour image.

In some embodiments, the angle of arrival may be determined from readings generated by two or more antenna arrays.

In some embodiments, the program instructions may be further executable by the processing unit for determining a travel distance of the electromagnetic wave signal from a position of the target vehicle when the electromagnetic wave signal is generated, and wherein the identifying one of the plurality of vehicles as the target vehicle is further performed on the basis of the determined travel distance.

In some embodiments, the image capture device may be part of an array of image capture devices, and wherein the receiving, the detecting and the identifying may be performed for more than one image capture device of the array of image capture devices.

In some embodiments, the image capture device may be a 360-degree camera.

In some embodiments, the image of the scene may be a depth image.

In some embodiments, the program instructions may be further executable by the processing unit for generating and transmitting an interrogation to the wireless licence plate of the target vehicle to receive the unique identifier.

In some embodiments, the unique identifier may be a licence plate number.

In some embodiments, the image of the scene may include virtual images of the target vehicle and one or more noise vehicles, wherein the identifying may include performing image analysis of the image of the scene using the angle of arrival to identify an object of the target vehicle in the image of the scene and distinguish the object of the target vehicle from the respective object or objects of the one or more noise vehicles appearing in the image of the scene.

In some embodiments, the program instructions may be further executable by the processing unit for extracting from the image of the scene a licence plate number of the one of the plurality of vehicles as the target vehicle.

In some embodiments, the program instructions may be further executable by the processing unit for comparing the extracted licence plate number to the unique identifier to determine a correspondence between the extracted licence plate number and the unique identifier.

Another broad aspect is a non-transitory computer-readable medium having stored thereon program instructions for identifying a mismatch between a unique identifier generated by a wireless licence plate of a target vehicle received at an antenna system and a licence plate number featured on a physical licence plate for the target vehicle, the program instructions executable by a processing unit for: receiving the unique identifier for the target vehicle via an electromagnetic wave signal generated by the wireless licence plate; receiving an image of the target vehicle from an image capture device; identifying a license plate for the target vehicle within the image and optically reading from the image a license plate number corresponding to the license plate; and verifying that the license plate number matches the unique identifier and, upon finding a mismatch, outputting a response indicating an occurrence of the mismatch.

In some embodiments, the image may include a plurality of vehicles including the target vehicle, and wherein the program instructions may be further executable by the processing unit for: determining travel information related to a transmission of the electromagnetic wave signal; and identifying one of the plurality of vehicles as the target vehicle on the basis of the location information, wherein the licence plate number is determined from an object of the target vehicle appearing in the image.

In some embodiments, the travel information may include an angle of arrival.

In some embodiments, the angle of arrival may include an azimuth angle and an altitude angle.

In some embodiments, the travel information may include a time of flight of the electromagnetic wave signal.

In some embodiments, the program instructions may be further executable by the processing unit for generating and transmitting an interrogation to the wireless licence plate of the target vehicle to cause a transmission of the unique identifier.

Another broad aspect is a non-transitory computer-readable medium having stored thereon program instructions for determining an absence of a response from a wireless licence plate of a target vehicle for reception at an antenna system, the program instructions executable by a processing unit for: receiving an image of the target vehicle from an image capture device; identifying a license plate for the target vehicle within the image and optically reading from the image a license plate number corresponding to the license plate; determining if a unique identifier transmitted via an electromagnetic wave signal received from a wireless licence plate corresponds to the licence plate number of the target vehicle; and upon determining an absence of the unique identifier that corresponds to the licence plate number of the target vehicle, generating an indication of the absence of receiving the unique identifier for the target vehicle.

In some embodiments, the program instructions may be further executable by the processing unit for generating and transmitting an interrogation to the wireless licence plate of the target vehicle for causing a transmission via the electromagnetic wave signal of the unique identifier.

In some embodiments, the program instructions may be further executable by the processing unit for, following the generating an indication of the absence of receiving the unique identifier for the target vehicle, generating and transmitting an alert to law enforcement.

Another broad aspect is a non-transitory computer-readable medium having stored thereon program instructions for verifying communication from a wireless licence plate associated to a target vehicle, the program instructions executable by a processing unit for: receiving an image of the target vehicle from an image capture device; identifying a license plate for the target vehicle within the image and optically reading from the image a license plate number corresponding to the license plate; and monitoring for a reception of an electromagnetic wave signal that transmits a unique identifier, and upon determining a presence of reception of the unique identifier following the monitoring based on travel information of the electromagnetic wave signal, generating an indication of the absence of reception of the unique identifier for the target vehicle.

In some embodiments, the program instructions may be further executable by the processing unit for, prior to the monitoring, generating and transmitting an interrogation for causing a transmission via the electromagnetic wave signal of the unique identifier by the wireless licence plate.

Another broad aspect is a non-transitory computer-readable medium having stored thereon program instructions for determining a presence of a wireless licence plate for a target vehicle, the program instructions executable by a processing unit for: receiving an image of the target vehicle from an image capture device; identifying a license plate for the target vehicle within the image and optically reading from the image a license plate number corresponding to the license plate; and performing a search to determine whether a unique identifier for a wireless licence plate corresponds to the licence plate number for the target vehicle.

In some embodiments, the program instructions are further executable by a processing unit for generating and transmitting an interrogation for causing a transmission via the electromagnetic wave signal of the unique identifier by the wireless licence plate.

### BRIEF DESCRIPTION OF THE DRAWINGS

The invention will be better understood by way of the following detailed description of embodiments of the invention with reference to the appended drawings, in which:

FIG. 1 is a block diagram of an exemplary vehicle identification system;

FIG. 2 is a block diagram of an exemplary computing device;

FIG. 3 is a block diagram of exemplary software architecture for obtaining information on a target vehicle;

FIG. 4 is a drawing of an exemplary image of a scene captured by an image capturing device;

FIG. 5 is a flowchart diagram of an exemplary method of obtaining additional information on a target vehicle associated to a wireless licence plate;

FIG. 6 is a flowchart diagram of an exemplary method of verifying a mismatch between a licence plate number and a unique identifier shared by a wireless licence plate for a target vehicle;

FIG. 7 is a flowchart diagram of an exemplary method for determining an absence of a response for a wireless licence plate;

FIG. 8 is a flowchart diagram of an exemplary method for determining a presence of communication from a wireless licence plate for a target vehicle;

FIG. 9 is a flowchart diagram of an exemplary method for determining an existence of a wireless licence plate for a target vehicle;

FIG. 10 is a drawing of an exemplary patrol vehicle with an exemplary camera and an exemplary antenna, for communication with wireless licence plates;

FIG. 11A is a drawing illustrating exemplary points of correspondence when a single antenna is used;

FIG. 11B is a drawing illustrating exemplary lines of correspondence when multiple antennas are used;

FIG. 12A is a drawing illustrating two exemplary vehicle images appearing in image space, where one of the vehicles images intersects with an exemplary line of correspondence, to identify a vehicle associated with the wireless licence plate; and

FIG. 12B is a drawing illustrating exemplary vehicles appearing in image space in an image with an exemplary line of correspondence when the images of both vehicles intersect with the line of correspondence, resulting in an ambiguous case.

### DETAILED DESCRIPTION

The systems and methods described herein permit the obtaining of additional information on a target vehicle possessing a wireless licence plate or that may possess a wireless licence plate. The additional information is derived from an image of a scene generated by an image capture device (e.g. a camera) that, e.g., may be located on a patrol vehicle. The image of the scene may be analyzed to identify an image object of the vehicle that is related to a unique identifier broadcast by a wireless licence plate, where the image of the scene may be analyzed to determine a licence plate number found in an image object representative of the physical licence plate of the vehicle, for purposes of verification of the identity and characteristics of the vehicle, as explained herein.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

From the foregoing it will be appreciated that, although specific embodiments have been described herein for purposes of illustration, various modifications may be made without deviating from the spirit and scope of the teachings. Accordingly, the claims are not limited by the disclosed embodiments.

### Definitions

In the present disclosure, by “patrol vehicle”, it is meant a vehicle that is collecting the identifying data of a target vehicle. Exemplary patrol vehicles include, but are not limited to, police vehicles, security or surveillance vehicles, etc.

In the present disclosure, by “vehicle”, it is meant a vehicle (e.g. land or road or air) of which identifying data (e.g. a licence plate number, an image of a vehicle) may be collected. A vehicle includes, but is not limited to, a car, a motorcycle, a truck, a jeep, etc.

### Exemplary Vehicle Identification System:

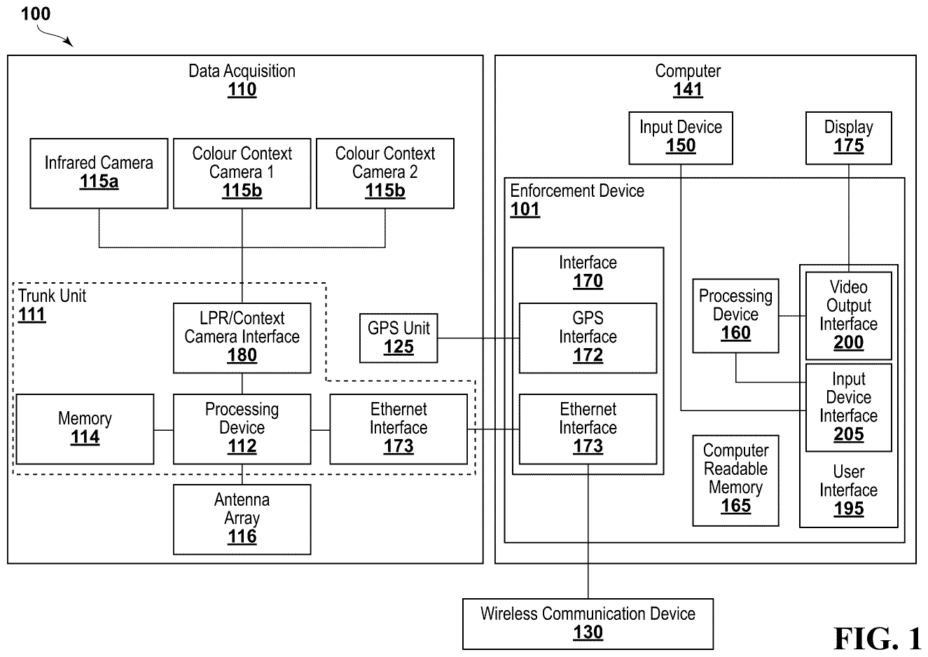

FIG. 1 illustrates a block diagram of the vehicle identification system 100 according to a first embodiment. As shown, the vehicle identification system 100 may comprise an enforcement device 101 which comprises the processing logic, memory and interfaces for performing vehicle identification with the vehicle identification system 100. The enforcement device 101 may be embodied within the computer 141.

The enforcement device 101 of this example comprises a processing device 160, which is a general-purpose programmable processor, namely in this example an Intel® Core™ i5-4300U vPro™ Processor running the Windows® 10 operating system.

The enforcement device 101 also comprises computer readable memory 165 in communication with the processing device 160, which stores program instructions and data used by the processing device 160.

The computer readable memory 165, though shown as a unitary module for simplicity may comprise several memory modules. In particular, it may comprise several layers of memory such as a hard-drive, external drive (e.g. SD card storage) or the like and a faster and smaller RAM module. The RAM module may store data and/or program code currently being, recently being or soon to be processed by the processing device as well as cache data and/or program code from a hard drive. A hard drive may store program code and be accessed to retrieve such code for execution by the processing device, and may be accessed by the processing device 160 to store vehicle data. The computer readable memory 165 may be non-transitory.

The enforcement device 101 comprises logic configured to perform the steps and interactions described herein. In this particular example, logic is provided by way of configuration of the processing device 160 by computer-readable program code stored in the computer-readable memory 165. The computer-readable program code implements a patroller service in software as described herein. It is to be understood that in this embodiment, the program code storing the instructions for the processing device 160 to implement the software are stored in the computer-readable memory 165.

The enforcement device 101 also comprises a user interface 195 which may communicate with the input device 150 and the display 154. The user interface 195 in this example comprises a video output interface 200 and an input device interface 205 for communicating with the display 145 and input device 150 respectively. In the present example, since the enforcement device 101 is implemented in the computer 141, the user interface 195 comprises elements of the computer 141 such as the graphic interface of the computer and the bus interface used by the keyboard. The video output interface 200 of this example comprises a video processing unit. In alternate examples, the display device may comprise a display that is driven by an HDMI input and is separately powered from the patrol vehicle 105's battery with the video output interface 200 comprising an HDMI interface and port. The video output interface is in communication with the processing device 160 for receiving therefrom content to be displayed on the display 145. The video processing unit of the video output interface 200 may in certain embodiments share the use of some of the computer-readable memory 165 but in this example it has its own dedicated high-speed memory (not shown).

The input device interface 205 interfaces with the input device 150, in this example a keyboard. In embodiments where the input device 150 is an external device, such as an external keyboard, the input device interface 205 may comprise a USB connection for connecting with a USB keyboard. The input device interface 205 is in communication with the processing device 160 via a data bus to provide thereto input received from the input device 150.

The enforcement device 101 also comprises a data acquisition hardware interface 170 for communicating with the data acquisition hardware 110 and particularly for receiving data therefrom. In this example, the data acquisition hardware interface 170 may refer to the various data interface(s) used to receive vehicle-related data, such as licence plate read data or a unique identifier from a wireless licence plate. In the example, vehicle data is received at the computer 141 over an Ethernet connection and the acquisition hardware interface 170 comprises the Ethernet interface 171 and the USB interface 172 when the GPS unit 125 is connected via USB, as is the case here.

The camera interface 180 (in some examples, each camera 115a and 115b may have its own camera interface) is in communication with a processing device 112, which in this example comprises a general-purpose programmable processor running an operating system, in this example Windows® 10 embedded. The trunk unit 111 also comprises computer readable memory 114 in communication with the processing device 112, which stores program instructions and data used by the processing device 112.

The license plate and context camera interface 180 is configured to communicate with the license plate and context camera 115, specifically in this example to receive image data therefrom, but which may in alternate examples also provide communications thereto such as commands to scan or recognize a license plate. In this example, license plate recognition is performed by the processing device 112 based on images received at the license plate and context camera interface 180 and transmitted to the processing device 112 via a data bus. In other embodiments, the data acquisition hardware may comprise a standalone license plate reader (or other vehicle identifier detector) which identifies license plate numbers (or other vehicle identifiers, such as permits, RFID tags, etc.) and provides them via a suitable communication medium, e.g. a USB interface, to the data acquisition hardware interface 170. Returning to the present example, as mentioned the license plate and context camera 115 captures two types of images, monochrome and color images, by two separate capture devices, an infrared camera and a color camera. These may in some embodiments be provided together, e.g. in synched superframes containing both infrared and color images, however in this example the license plate and context camera 115 provides monochrome and color images as separate streams. These may be any suitable connections; in this example they are custom made cable connections that transport power to the camera and data therefrom. The license plate and context camera interface 180 comprises a bus interface which receive image data from the infrared and color cameras and transmits them via one or more data buses to the processing device 112. Camera 115b may be a 360-degree camera.

The computer readable memory 114, though shown as a unitary module for simplicity may comprise several memory modules. In particular, it may comprise several layers of memory such as long term persistent storage (e.g. a hard-drive or external drive) or the like and a faster and smaller RAM module. The RAM module may store data and/or program code currently being, recently being or soon to be processed by the processing device as well as cache data and/or program code from a hard drive. The long term storage may store program code and be accessed to retrieve such code for execution by the processing device 112, and may be accessed by the processing device 112 to store data. The memory 114 may be non-transitory.

The data acquisition device 110 also includes logic configured to receive camera data from the various cameras, perform image capturing, OCR, analytics and event generation (e.g. plate read). In this particular example, logic is provided by way of configuration of the processing device 112 by computer-readable program code stored in the computer-readable memory 114. The computer-readable program code implements a trunk unit software. The program code storing the instructions for the processing device 112 to implement the software are stored in the computer-readable memory 114.

The data acquisition device 110 may also include a second context camera 115b for taking at least one additional context image of a target vehicle. In the examples where the data acquisition device 110 has two context cameras 115b (where one of the context cameras 115b may be in the same housing as the infrared camera 115a), the first and the second context camera 115a may be positioned on the patrol vehicle with different orientations one from the other.

In order to communicate with the enforcement device 101, the data acquisition hardware 110 comprises an Ethernet interface 173, which allows network communication with the computer 141.

The GPS interface 172 is configured to communicate with the GPS unit 125. In this particular example, the GPS unit 125 comprises a GPS antenna and a receiver which comprises GPS logic for receiving GPS signals, temporal information (e.g. time) and compute a location based thereon. The GPS unit 125 communicates with the GPS interface 172 via a suitable medium, here a USB connection, and transmits location information, here in the form of NMEA formatted positioning data, to the GPS interface 172. The GPS interface 172 comprises a USB port and interface and communicates the received GPS to the patroller service 610 software running on the processing device 160. In alternate embodiments, the GPS logic for determining a location based on GPS signals may be provided within enforcement device 101, for example within the GPS interface 172. In such a case, the GPS unit 125 may comprise the GPS antenna and the communication with the GPS interface 172 may be over a shielded connection that transmits directly the GPS signals as received. The GPS interface 172 would then comprise demodulation logic to interpret the received signals. While GPS is used in this example, it has already been mentioned that other types of location hardware may be used, such as dead reckoning systems. Other satellite-based or terrestrial antenna-based location systems may also be used.

The data acquisition device 110, or the enforcement device 101, may also have another device, such as a clock, for generating the temporal data (e.g. time of day or a chronometer for calculating the time lapsed from a particular event).

The enforcement device 101 also comprises a wireless interface which communicates with the wireless communication device 130. Although shown as separate from the enforcement device 101, this and other units may be provided on-board or within the housing of the enforcement device 101. The wireless communication device of this example comprises a cellular network modem for communicating data wirelessly with a cellular network, particularly here using the LTE and/or 3G standard. The Ethernet interface 171 is in communication with the wireless communication device 130 and provides data to the wireless modem to transmit to a remote address, in this case over the internet, and receives data from the wireless modem. Thus, in this example the Ethernet interface 171 serves as the wireless interface although in other examples a separate interface may be provided to communicate with the wireless communication device. The wireless communication device 130 provides internet connectivity to the connected components. Although in this example the wireless communication device 130 uses certain cellular data standards, other wireless communication standards, and other media such as satellite communication may be used in its stead or to complement it.

The wireless interface in this example takes the form of the Ethernet interface 171 which provides routing to and from the wireless communication device 130.

The illustrated example is exemplary only. It is conceivable, for example that using a particular system-on-a-chip, certain components shown separately be integrated with the processing device 160. For example, the processing device 160 may comprise software code modules for receiving, formatting, interpreting and/or storing data received from data acquisition hardware 110 or the user interface system 140 and may include an on-chip video processing unit.

An antenna system comprising one or more antenna arrays 116 may be included in the data acquisition device 110. The antenna array 116 may be in communication with the processing device 112 of the trunk unit 111. The antenna array 116 receives an electromagnetic wave carrying a unique identifier for a target vehicle, the electromagnetic wave generated by a wireless licence plate of that target vehicle. The configuration of the antenna array 116 may also permit determining an angle of arrival (e.g. an azimuth angle and/or a zenith angle and/or an altitude angle) for the electromagnetic wave generated by the wireless licence plate, providing information on the location of the target vehicle with the wireless licence plate. In some instances, the antenna array may also be configured to gather information for calculating a travel distance of the electromagnetic wave originating from the target vehicle, which may be used for estimating a distance of the target vehicle generating the electromagnetic wave from the patrol vehicle.

The antenna array 116 may be positioned on the patrol vehicle (e.g. a hood of the patrol vehicle, a roof of the patrol vehicle, a bumper of the patrol vehicle, etc.) When more than one antenna array 116 is present, each of the more that one antenna arrays 116 may be positioned at a different location on the patrol vehicle.

A time-of-flight sensor may also be provided (e.g. in communication with the processing device 112 of the trunk unit 111) to establish a time-of-flight measurement with a vehicle (e.g. a vehicle with a wireless licence plate that has broadcast a unique identifier).

### Exemplary Software Architecture for Obtaining Information on a Target Vehicle:

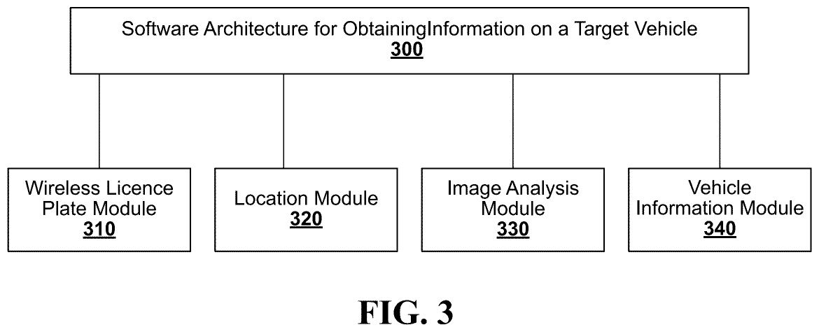

Reference is made to FIG. 3, illustrating exemplary software architecture for obtaining information on a target vehicle 300. The software architecture 300 may be stored in memory 114 of the trunk unit 111, for execution by its processing device 112, stored in memory 165 of the enforcement device 101 for execution by the processing device 160, or stored in memory of a separate computing device, and/or distributed across these different devices, for execution by the processing device of this computing device, this computing device in communication with or part of the vehicle identification system 100.

The software architecture 300 includes a wireless licence plate module 310, a location module 320, an image analysis module 330 and a vehicle information module 340. Each of the wireless licence plate module 310, the location module 320, the image analysis module 330 and the vehicle information module 340 includes program code configured to implement the functionality of the modules as are described herein.

The wireless licence plate module 310 includes program code stored in memory that, when executed by a processor, causes the processor to receive a unique identifier communicated by an electromagnetic wave (a signal) emitted by a wireless licence plate for a target vehicle. In some instances, the wireless licence plate module 310 causes the processor to generate and emit an interrogation to cause a wireless licence plate to emit, in response, the electromagnetic wave communicating the unique identifier. In some instances, a wireless licence plate may be continuously broadcasting the unique identifier, where the wireless licence plate module 310 causes the processor to receive the broadcasted signal with the unique identifier (e.g. received at the antenna array 116). In some instances, the wireless licence plate module 310 may cause the processor to decrypt the received wireless identifier, and/or analyze data transmitted with the wireless identifier (such as vehicle information, a timestamp of emission of the electromagnetic wave with the unique identifier, etc.) It will be understood that, in some instances, the electromagnetic wave communicates other information on the target vehicle along with the unique identifier, such as a model of the vehicle, a colour of the vehicle, a year of the vehicle, identity of the owner of the vehicle, etc.

The unique identifier for the target vehicle may be different from the licence plate number for the target vehicle. In some instances, the unique identifier may be or may include the vehicle identification number (VIN) for the target vehicle or another ID specifically for wireless identification ID transmission.

The location module 320 includes program code stored in memory that, when executed by a processor, causes the processor to determine travel information on a direction of arrival and/or location of transmission of the electromagnetic wave that communicates the unique identifier. For instance, the travel information may include an azimuth angle, an altitude angle, a zenith angle (collectively referred to as an angle of arrival) and/or a travel distance of the electromagnetic wave from the wireless licence plate to the antenna receiving the electromagnetic wave. For instance, the system 100 may include one or more antenna arrays 116, where the travel information is derived from the readings received from the one or more antenna arrays 116.

The image analysis module 330 includes program code stored in memory that, when executed by a processor, causes the processor to analyze an image of a scene generated and received from an image capture device (e.g. a camera) to obtain information on vehicle objects identified in the image. For instance, the image analysis module 330 causes the processor to convert the travel information generated by the processor executing the program code of the location module 200 into values that can be used to determine, within the image of the scene, a location of a vehicle object corresponding to the target vehicle with the wireless licence plate that originated the wireless licence plate signal. For instance, the image analysis module 330 may cause the processor to perform object recognition to identify image object(s) corresponding to one or more vehicles appearing in the image. The travel information may then be analysed by the processor executing the program code of the image analysis module 330 to identify which of the vehicle image objects identified in the image corresponds to the target vehicle, e.g. through the use of vectors and angles derived from the travel information matches to the image space of the image of the scene.

In some embodiments, the image analysis module 330 may cause the processor to convert the travel information into values corresponding to the image space of the image of the scene, and determine a location within the virtual space of the image of the scene of a vehicle image object (i.e. of the target vehicle with a wireless licence plate originating the electromagnetic wave). Image analysis may then be performed to confirm that a vehicle image object is located at a location in the image space. Upon confirming that a vehicle image object is located at the location in the image of the scene, the vehicle image object may be designated as the vehicle image object corresponding to that of the target vehicle.

The vehicle information module 340 includes program code stored in memory that, when executed by a processor, causes the processor to extract information on the target vehicle from the object of the target vehicle identified in the image of the scene. For instance, object recognition performed on the portion of the image defining the vehicle object of the target vehicle may identify the object of the licence plate for the target vehicle. Character recognition may be performed on the object of the licence plate to generate the licence plate number. The object of the target vehicle may also be analyzed to determine a vehicle model, a colour of the vehicle, etc.

The vehicle information module 340 may further cause the processor to store the information on the target vehicle derived from the image with the unique identifier (and other information) communicated via electromagnetic wave by the wireless licence plate. In some embodiments, the vehicle information module 340 may further cause the processor to compare the information of the target vehicle derived from the image of the scene to the information received from the wireless licence plate.

### Exemplary Method of Obtaining More Information on a Target Vehicle Associated to a Wireless Licence Plate:

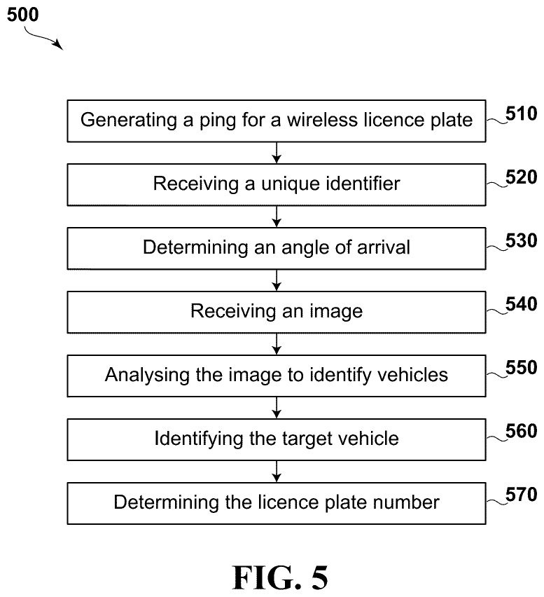

Reference is now made to FIG. 5, illustrating an exemplary method 500 of obtaining additional information on a target vehicle associated to a wireless licence plate. The method may be performed by system 100, any other system in accordance with the present teachings, or by a computing device in communication with a system in accordance with the present teachings such as system 100. The methods described herein may be performed with respect to a patrol vehicle, or with respect to a stationary system with the features of system 100 (e.g. a post-mounted system).

In some instances, an interrogation may be generated for transmission to a wireless licence plate at step 510, to cause a broadcasting of a unique identifier in response to the interrogation, by the wireless licence plate. The wireless licence plate is associated to a target vehicle, thereby adapted to provide information on the target vehicle.

A requirement of generating an interrogation to cause a broadcast of the unique identifier may depend upon the wireless standard or protocol used by the wireless licence plates, and energy consumption considerations regarding the wireless licence plate (where a continuous broadcast of the unique identifier may consume more energy than transmitting the unique identifier signal in response to a reception of a interrogation). For instance, a possible wireless standard used by the wireless licence plates may be BLE (Bluetooth Low Energy). it will be appreciated that other wireless transmission systems suitable for use in vehicle-to-vehicle or vehicle-to-fixed communications, suitable for communication on roads, may be used.

In some instances, depending on the wireless protocol, the wireless licence plate may be continuously broadcasting a signal with the unique identifier, for reception by neighbouring antennae, where no interrogation is first required to cause the broadcasting of the unique identifier by the wireless licence plate.

The unique identifier, transmitted via an electromagnetic wave by the wireless licence plate, is received at step 520. The wireless broadcast by the wireless licence plate may be encrypted. Additional information on the vehicle associated to the wireless licence plate may be transmitted, as data, along with the unique identifier, such as, for instance:
the licence plate number;
the model of the vehicle;
the year of the vehicle;
the identity of the owner of the vehicle;
the colour of the vehicle;
a timestamp indicative of a time of broadcast of the electromagnetic wave;
etc.

Travel information, such as an angle of arrival, is then determined for the electromagnetic wave carrying the information on the unique identifier at step 530. The travel information permits a determination of a location and/or direction of the origin of the wireless licence plate that generated the electromagnetic wave. For instance, the travel information may include, as an angle of arrival, an azimuth angle (an angle measured along a first, typically horizontal, plane) and/or a zenith angle or altitude angle (an angle measured along a second, typically vertical, plane). The angle or arrival may be defined by one or more vectors. It will be understood that the angle of arrival may be any angle that can be translated to an azimuth angle or altitude angle. Likewise, the term azimuth angle and altitude angle are meant to encompass equivalents such as any value that expresses the same measure differently and can readily be translated respectively into the azimuth angle and altitude angle. For example, although an altitude angle is usually the angle measured from the horizontal plane up to a point, the zenith angle which is typically the angle measured from the vertical down to the point is typically complementary to the altitude angle, meaning that it is equivalent to 90 degrees minus the altitude angle. When used herein, altitude angle covers both the altitude and zenith angles since they are just different ways of expressing a same coordinate component.

The travel information may include a distance value corresponding to a travel distance of the electromagnetic wave from the wireless licence plate emitting the electromagnetic wave to the antenna receiving the electromagnetic wave.

One or more antenna arrays may be used (e.g. located on the patrol vehicle, where each of the antenna arrays may be located at a different position on the patrol vehicle) to determine the travel information. Each of the antennas of the array of antennas may receive the electromagnetic wave transmitted by the wireless licence plate. The difference in reception time of the electromagnetic wave by each of the antennas of the antenna array, combined with known positions of the antennas of the antenna array with respect to one another, may be measured to derive the angle of arrival. For instance, the antenna array may enable the performance of beam forming, where signals at particular angles experience constructive interference with respect to one another (e.g. where a fixed set of weightings and/or time-delays may be used). Beam forming may be performed in the frequency domain or the time domain.

When two or more antenna arrays are present, each of the antenna arrays may be positioned and separated by a known distance with respect to one another. For instance, one antenna array may be located on a front bumper or hood of the patrol vehicle, where another antenna array may be located on a roof of the patrol vehicle (e.g. integrated into the plexiglass of the vehicle).

Systems may be provided for deriving the azimuth and altitude angles, or other equivalent orientation of a signal source and approximate distance to a wireless license plate, and communications may be established with these systems to receive the derived values. The values received from these systems may be transformed to make it suitable for present use, e.g. by translating the data to a different descriptive system such as a different coordinate system, or translating the origin of the coordinate system to a different location, such as centered about a center point of the system/patrol vehicle or centered about a center of the image capture system.

A distance may be calculated following a use of two or more antenna arrays located, e.g., at different positions on the patrol vehicle (e.g. using, for instance, a time-of-flight sensor). It will be understood that any system suitable for obtaining relative position information from the source of a wireless signal may be used to determine this distance value.

In some instances, the distance value(s) and the angle value(s) may be provided by an external system.

In some instances, global positioning system (GPS) coordinates may be transmitted with the unique identifier as part of information transmitted via the wireless signal of the wireless licence plate. The GPS coordinates may be used to define the travel information of the electromagnetic wave signal, such as defining the distance travelled by the electromagnetic wave (e.g. when the position of the receiving patrol vehicle is also known) and/or angle(s) of arrival of the electromagnetic wave signal.

An image of a scene, captured by an image capture device, is received at step 540. The image capture device may be a camera, such as a red-blue-green (RGB) camera. The image capture device may be a 360-degree camera. The camera may have a pan, tilt and/or zoom function.

The image may be a colour image. The image may be in grayscale.

The image may be that of a road, where the target vehicle may be located.

In some embodiments, a plurality of images, or a stream of images, may be received, where the plurality of images shows a change in the scene over time. A plurality of image capture devices may be provided, where the image capture devices generate simultaneously images of the scene with different fields of view.

The image of the scene may be received (which may include generating or transmitting of the image of the scene) at a same time as or contemporaneously with the reception of the electromagnetic wave signal carrying the unique identifier (by at “a same time” or “contemporaneously” as used interchangeably herein, it may mean within a tolerance in time from one another that has been defined in the system as acceptable). In some instances, the image of the scene may not be received at a same time as the reception of the wireless signal with the unique identifier, where more than a period of time, defined as a threshold value in the system, may have lapsed, where computing a change in position of the patrol vehicle from a time of reception of the image of the scene and a time of reception of the unique identifier may be factored in when converting the travel information from real space to image space as described herein.

The image of the scene is analyzed at step 550. In some embodiments, the analysis is performed to identify an object in the image corresponding to the target vehicle, in the virtual space of the image, that is associated to the wireless licence plate that generated the electromagnetic wave communicating the unique identifier.

In some embodiments, object recognition may be performed on the image to identify objects present in the image that correspond to vehicles. For instance, the object recognition may recognize in the image constellations of pixels or patterns corresponding to known traits of vehicles. The objects corresponding to vehicles are identified in the image. The area of the image of the scene corresponding to the object of the vehicle in image space may be defined by pixel coordinates (e.g. in x, and y: a number of pixels measured from a vertical edge or horizontal edge respectively of the image of the scene). The vehicle object may be defined as a blob, corresponding to a plurality of macroblocks (the vehicle object split into a grid of squares or parallelograms containing a number of pixels, and the vehicle location may correspond to in which of these squares or parallelograms the vehicle is located).

In instances where multiple images are received from an image capture device or from multiple image capture devices, object recognition may be performed on each of the images to identify object(s) corresponding to vehicles appearing in the each of the images.

The virtual object corresponding to the target vehicle associated to the wireless licence plate that transmitted the electromagnetic wave sharing the unique identifier is determined at step 560.

The travel information of the electromagnetic wave carrying the unique identifier is analyzed to convert the travel information into one or more vectors in the virtual space of the image corresponding to the travel information in real space.

An offset in time between the capturing of the image of the scene and the time of receipt (or transmission) of the electromagnetic wave sharing the unique identifier may also be factored when performing the conversion from real space to image space, where the offset in time may result in the patrol vehicle moving with respect to the target vehicle, or vice versa. Namely, the vectors generated from the travel information derived from the one or more antenna arrays may be matched to the field of view of the image capture device that captured the image of the scene, where values for the position of the image capture device are known (e.g. position of the image capture device on the patrol vehicle, a pan value, a tilt value, a value of position in x, y and z).

In some instances, a distance from the image capture device to a vehicle may be derived based on a horizontal disparity between a difference in a blob or image object appearing in two images taken at a same time by two image capture devices positioned at two different positions with respect to one another. In other instances, other depth-measuring technologies may be used.

A position of the array of antennae (e.g. coordinates or a range of coordinates) that captured the electromagnetic wave may be defined (e.g. relative to the image capture device).

The following exemplary set of calculations is provided to enable the skilled person to better understand the present disclosure. As it is but an illustrative and representative example, it should not limit the scope of the present disclosure. It is only added for illustrative and representative purposes. It will be understood that other exemplary sets of calculations may be used to further illustrate and represent the present disclosure without departing from the present teachings.

The conversion of the travel information from real space to image space of the image of the scene may also account for a difference in position of the image capture device that generated the image of the scene, with respect to the position of the one or more antennae that are the basis for the generating of the travel information (e.g. as the image capture device may be located on the patrol vehicle at a location that is different from the location of the one or more antennae).

In some instances, position parameters may be projected from one space into another (e.g. real space into image space, or vice versa). A space geolocation of an object in the image may be matched to the travel information obtained from the antenna array(s) (a geolocation in real space), or vice versa. Tolerances may be defined when performing the match between real space and virtual space.

In one example where the image capture device is directed in a same direction as the antenna array, a conversion between the image space and real space may be performed as follows.

A horizontal position of the object in the image, x_{image}, may be obtained as follows, where:
α is azimuth angle.
θ_{horiz} is the total horizontal field of view of the camera (an angle value).
image width is the number of pixels wide of the image.
image width/2 is the horizontal center of the image.

$$Ximage = \frac{α}{θ horiz} \times image width + ( image width / 2 )$$

The formula may be performed multiple times to achieve multiple horizontal positions in the image.

A vertical position may also be measured (e.g. if the height of the image capture device with respect to the ground is known).

If the travel information includes an altitude angle, y_{image}, the vertical position of the object in the image may be calculated as follows:
β is altitude angle.
θvert is the total vertical field of view of the camera (an angle value)
image height is the number of pixel high of the image.
image height/2 is the vertical center of the image.

$$Yimage = \frac{β}{θ vert} \times image height + ( image height / 2 )$$

The formula may be performed multiple times to achieve multiple vertical positions in the image of the scene.

Adaptations may be performed to account for translational or angular offsets.

In some embodiments, when the travel information includes geolocation, the geolocation may be provided using a cartesian coordinates rather than polar coordinates. In some instances, the geolocation may refer to a specific point, and in other embodiments, the geolocation may refer to an area, e.g. as defined by a range of possible values in any or all coordinates (e.g. azimuth is between α₁ and α₂, altitude is between β₁ and β₂, or distance is between r₁ and r₂). Similarly, objects in images may be defined by areas rather than point values, as is known.

In one example where a measure of distance between the antenna array and the target vehicle is not included in the travel information, two dimensions of a polar coordinate system (e.g. you have the theta angle [or yaw] (azimuth) and the phi angle [or pitch] (altitude) but not the radius [or distance]) may be obtained. A range for each value may also be determined (e.g. phi: between 45 and 50 degrees right of center”; theta: “between 10 and 20 degrees up from the horizontal plane”; radius: not none or “4-5 meters away”).

In some instances, the antenna array may only operate on a 2D plane, where only an angle in the horizontal plane is obtainable.

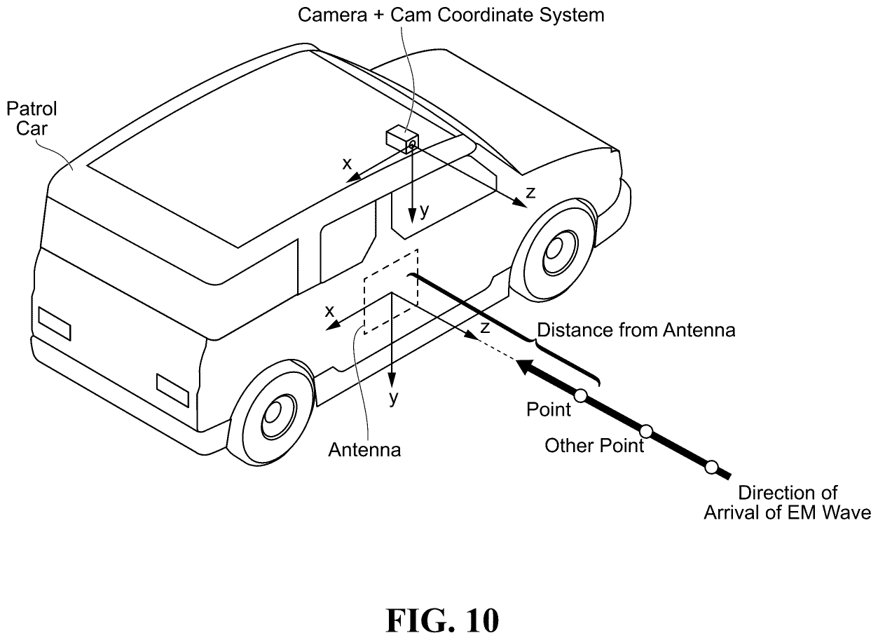

In some embodiments, as shown in FIG. 10, when the camera is not collocated with the antenna, then the angle of arrival of the electromagnetic wave signal may not correspond to a single point in the image, but to a line in the image. In some instances, the relative position and orientation of the camera will be known because, for example, the relative position and orientation of the camera may be measured at its time of installation.

In some implementations, as shown in FIG. 10, the line in the image that corresponds to the angle of arrival of the electromagnetic wave signal can be determined through the following:
take a point at some distance from the antenna, in the direction of arrival of the electromagnetic wave;
express the point in the coordinate system of the antenna (Xantenna, Yantenna, Zantenna).
perform a coordinate system transformation to express the point in the coordinate system centered on the camera, considering the relative rotation and translation of the antenna and camera:

$$( \begin{matrix}Xcamera \\ Ycamera \\ Zcamera\end{matrix} ) = M ( \begin{matrix}Xantenna \\ Yantenna \\ Zantenna\end{matrix} ) + T$$

where M and T are respectively the rotation matrix and the translation vector that express the relationship between the camera and the antenna coordinate systems;
perform a projective transformation to express the point in the image coordinate system, by dividing the real space coordinate X and Y by the Z coordinate, by multiplying the result by the camera focal length, by dividing the result by the physical camera image sensor pixel dimensions, and by adding half the image size (measured in pixels):

$$Ximage = \frac{Xcamera}{Zcamera} \times \frac{Focal length}{Pixel dimension} + ( image width / 2 )$$

$$Yimage = \frac{Ycamera}{Zcamera} \times \frac{Focal length}{Pixel dimension} + ( image height / 2 )$$

repeat this operation for many points at different distances from the antenna, and connect those points in the image, forming the line where the angle of arrival corresponds in the image.

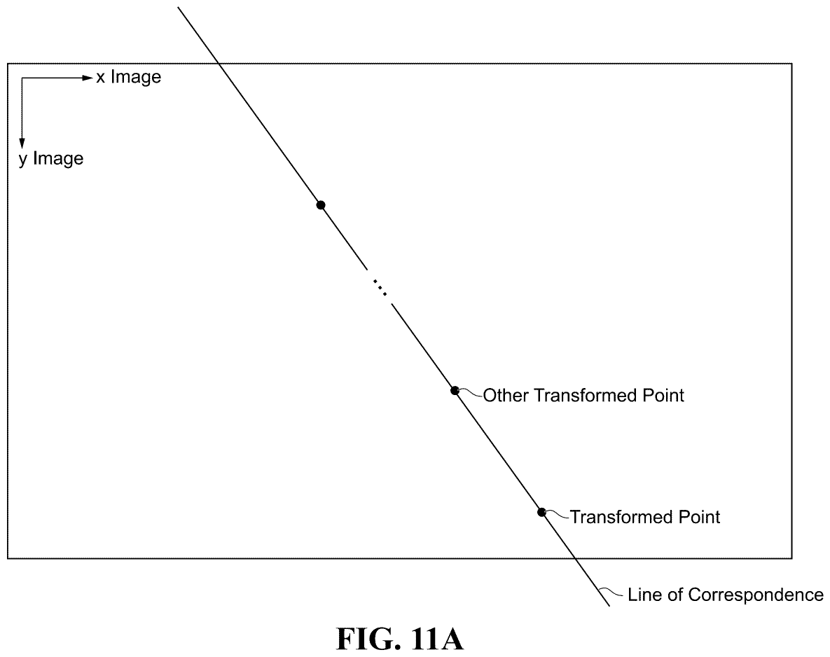

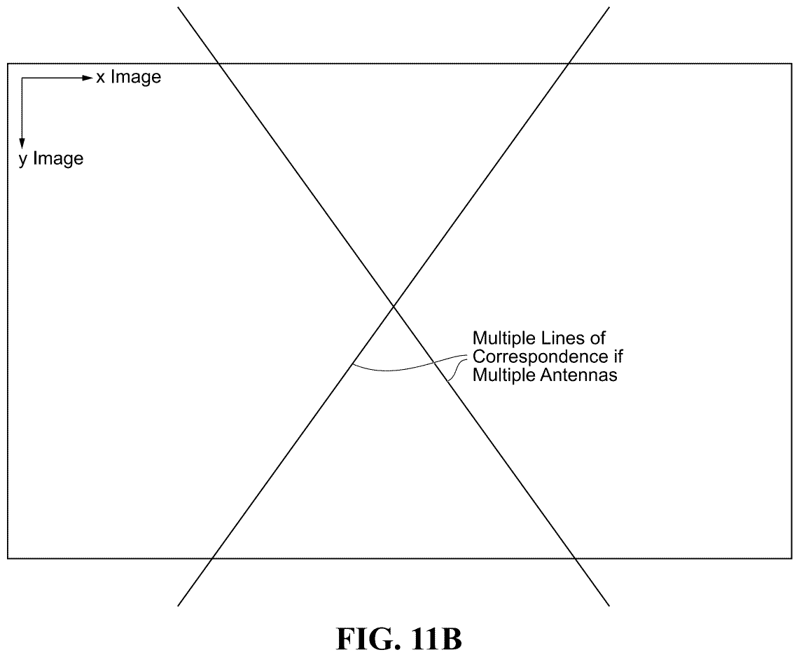

FIG. 11A illustrates an exemplary line of correspondence relating to the antenna.

If the travel information contains a distance information, the above steps can be performed with respect to a single point, leading to a single point of correspondence in the image.

If the image and the electromagnetic wave information are not acquired at the same time, and if the patrol vehicle moves, then the relative position and orientation of the camera and the antenna do not only depend on the installation characteristics of these devices (e.g. antenna, camera), but also on the motion of these devices (e.g. antenna, camera). With respect to the exemplary steps described above, the coordinate system transformation between the antenna coordinate system and the camera coordinate system may be corrected to add the translation and rotation that the camera experienced during the time difference between the two acquisition times.

The translation and rotation of the camera caused by the patrol vehicle motion can be extracted from a GPS system and/or from an inertial navigation system in the patrol vehicle.

If there is more than one antenna on the patrol vehicle, then the travel information acquired by each of these antennas can lead to one line of correspondence in the image per antenna, as shown in FIG. 11B.

If the patrol vehicle moves during the acquisition, then the above procedure may be repeated at different times, leading to a plurality of images, each one with a line (or lines) corresponding to the angle of arrival of the electromagnetic wave.

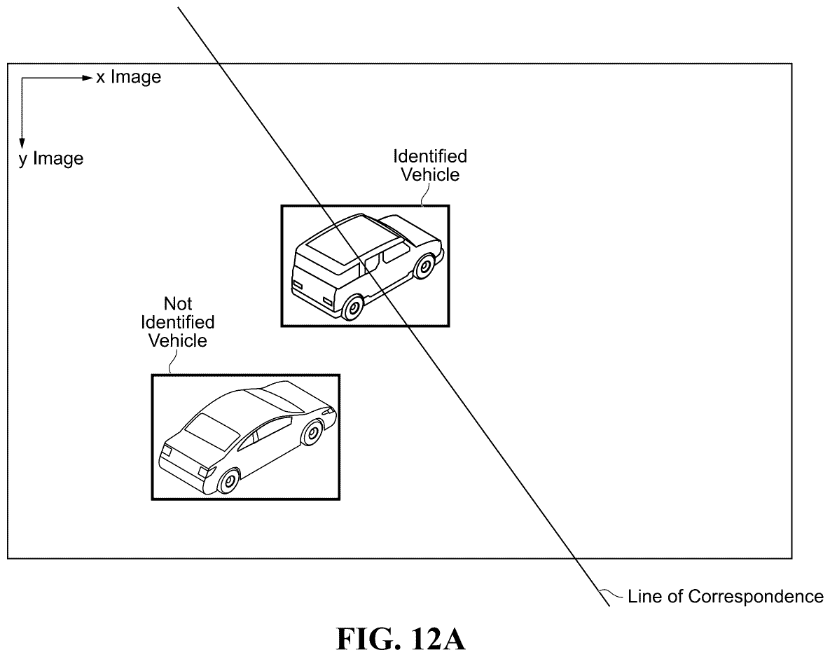

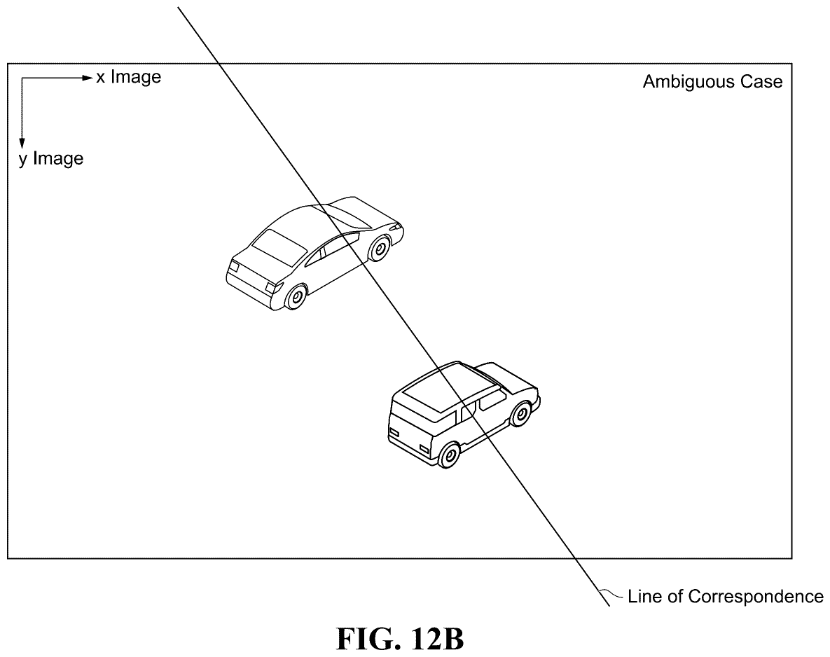

To identify, in the image, the target vehicle that corresponds to the electromagnetic wave, a method may consider as the target vehicle the one that is close enough to the determined line of correspondence (or close enough to all the lines of correspondence that have been determined), as shown in FIG. 12A. If there are multiple vehicles that are close enough to the line of correspondence (or close enough to the all the lines of correspondence), then the identification may be considered ambiguous, as illustrated in FIG. 12B, and this information can be stored in a data base or repository.

The one or more vectors calculated from the travel information, once matched in image space, are applied to the image to identify, in the image space, the object of a vehicle that corresponds to the target vehicle. Determining a direction of arrival of the electromagnetic wave to the receiving antenna may be used to identify the location of the target vehicle when the electromagnetic wave was transmitted, and an application of that matched travel information in the virtual space of the image of the scene enables the locating of the object of the target vehicle with the wireless licence plate that generate the electromagnetic wave in the virtual space of the image.

A licence plate number of the target vehicle is determined from the object of the target vehicle appearing in the image of the scene at step 570.

Further object recognition may be performed on the identified image of the target vehicle identified in the image of the scene to identify an object corresponding to a licence plate. For instance, an object recognition function may scan for certain pixel constellations or patterns (e.g. licence plate corners) appearing in the object of the target vehicle to identify the licence plate object.

Once the licence plate object has been identified in the image of the scene, character recognition may be performed on the licence plate number to determine the string of characters appearing in the licence plate object, corresponding to the licence plate number. Once identified, the licence plate number may be stored in memory along with the unique identifier received from the wireless licence plate.

In some embodiments, when a plurality of images is received from the image capture device, as the target vehicle may appear in different positions in each of the images, taken at a different time, an object of a licence plate may not be recognized in each of the images. Object recognition may be performed on each of the images to determine if a licence plate object is visible in each of the images.

In some instances, more information on the target vehicle may be derived from the object of the target vehicle appearing in the image of the scene. For instance, a colour of the vehicle may be determined from the object of the target vehicle. In one example, characteristics of the target vehicle may be further derived from the object of the target vehicle identified in the image (such as the make of the vehicle, the model of the vehicle, the year of the vehicle, etc.), e.g., by comparing the features of the object of the vehicle appearing in the image to a database of images of known vehicle makes and models. In other instances, a vehicle signature may be derived, such as may be obtained via a reidentification algorithm yielding as a signature a reidentification vector.

In some instances, further information may be obtained on the target vehicle by querying a database (e.g. a DMV database), based on, for example, the unique identifier or the licence plate number (e.g. owner of the vehicle, characteristics such as appearing and criminal activity of the owner of the vehicle, colour of the vehicle, year of the vehicle, model of the vehicle, driver's driving permit number, etc.) The information on the target vehicle, either retrieved from the database or obtained from the image of the scene and/or unique identifier, may be displayed on a screen visible by a user (e.g. law enforcement officer, security guard, etc.), so that, e.g. the law enforcement vehicle can decide, based upon the displayed information, to give chase to the vehicle. A vehicle event may be generated, the vehicle event being a data structure including fields with information on the target vehicle, such as the unique identifier transmitted by the wireless licence plate, the licence plate number, information on the owner of the vehicle (name, appearance, criminal history and/or status, etc.), a VIN for the vehicle, etc. The information defined in the vehicle event may be displayed on a display for viewing by a user, transmitted to a remote server, stored in memory, etc.

In some embodiments, the image of the scene may contain metadata providing information on what is displayed in the image of the scene. For instance, the metadata of the image of the scene may include, e.g. in association with the object of the vehicle or the object of the licence plate, metadata storing the unique identifier received from the wireless licence plate of the vehicle. Other metadata stored in the image of the scene may include the licence plate number that has been recognized in the image of the scene, colour of the vehicle, the model of the vehicle, etc. In some embodiments, a query may be transmitted to a registry or database, based on the received unique identifier, to retrieve the licence plate number or further vehicle information corresponding to the target vehicle corresponding to the unique identifier from which the query is based. At least some of the information received in response to the query, including the licence plate number, may be stored as metadata in the image of the scene (e.g. in association with the object of the vehicle defined in the image of the scene). In some instances, the metadata may be caused to be displayed on a graphical user interface with the image of the scene (e.g. in a window appearing on the display producing the graphical user interface).

In some instances, vehicle events may be generated, which combine information about a vehicle such as its location (in the image of the scene, determined form the wireless signal location, or in a real or virtual space computed based on either of the foregoing, etc.), its license plate number, unique identification number, other information such as visual signature, etc. The vehicle event may be stored with reference to an associated video or within the video metadata. Video metadata may then be augmented and may include analytics on the video itself with data obtained by performing the method(s) described herein.

In some instances, a failure to recognize a licence plate number for the target vehicle in the image of the scene may occur. This failure to identify a corresponding licence plate number may be logged or recorded in memory, for instance, in association with the unique identifier for the target vehicle. A failure to recognize a licence plate number may be due to the position of the vehicle captured in the image of the scene resulting in the licence plate not being visible, a removal of the licence plate from the vehicle, obscuring the licence plate with mud, dirt or snow, etc.

### Exemplary Method of Determining a Mismatch Between a Unique Identifier Transmitted by a Wireless Licence Plate and a Licence Plate Number Identified in an Image:

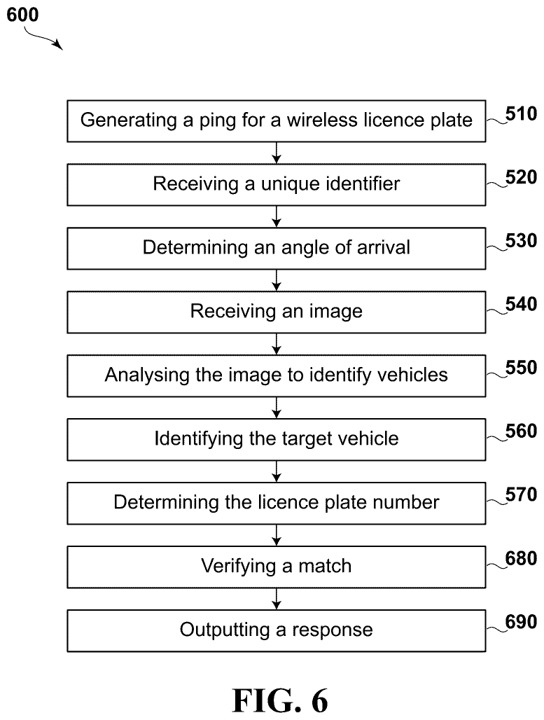

Reference is now made to FIG. 6, illustrating an exemplary method 600 of determining a mismatch between a unique identifier transmitted by a wireless licence plate associated to a target vehicle, and a licence plate number corresponding to an image object of a target vehicle identified in an image. The method may be performed by system 100, any other system in accordance with the present teachings, or by a computing device in communication with a system in accordance with the present teachings such as system 100.

Steps 510-570 are performed as described with respect to method 500, as illustrated in FIG. 5.

The output of performing steps 510-570 is a determination of a licence number identified from a licence plate object found in the image of the scene with an image object of the target vehicle in the image of the scene, and a unique identifier corresponding to the target vehicle that has been transmitted by a signal emitted by the wireless licence plate associated to the target vehicle.

As such, steps 510-570 result in the obtaining of both a unique identifier for the target vehicle and a licence plate number for the target vehicle.

It will be understood that in some instances, the receiving and analysis of an image, as well as the identifying of the vehicle in the image, corresponding to steps 540-560, may be performed prior to the receiving a unique identifier and determining travel information for the signal carrying the unique identifier, corresponding to steps 520 and 530 (and optionally 510), prior to performing steps 680-690. In other words, a determination of a location of a target vehicle in image space with respect to the patrol vehicle may be performed during the image analysis, corresponding to steps 540-570, and then a monitoring for a signal from a wireless licence plate may be performed by converting the location information of the target vehicle in image space to real space. A reception of a signal from a wireless licence plate from a direction that corresponds to the travel information may then be used for purposes of verifying a mismatch, based on steps 680-690 as explained herein.

A database or registry stored in memory (a local memory or remote memory of a remote database) may be queried, using either the unique identifier or the licence plate number, to retrieve the expected licence plate number of the unique identifier, respectively, stored in memory, for the target vehicle. The database or registry may store a directory of licence plate numbers and corresponding unique identifiers for vehicles found in the database or registry.

A verification of the obtained licence plate number-unique identifier pair with the expected licence plate number-unique identifier pair is performed at step 680. Values found in the field for “unique identifiers” are compared, and/or values for the field for “licence plate number” are compared.

If a mismatch is detected between the received unique identifier and the identified licence plate number when compared to the expected unique identifier and the expected licence plate number, an indication of the mismatch is generated and output at step 690.

In some embodiments, a message or warning may be generated for display on a screen of a computer of a law enforcement officer, or transmitted to a security service or a database of a law enforcement unit, alerting of the mismatch. In some instances, an audio alert, visual alert and/or tactile alert (a vibration) may be generated to alert an operator of a mismatch between the unique identifier and the licence plate number.

In some instances, a record of the mismatch event between the unique identifier and the licence plate number may be stored in memory (e.g. of the system or in an external database).

In some instances, additional values may be compared between two or more of the information received via the electromagnetic wave from the wireless licence plate, the information derived from the image of the scene regarding the target vehicle and the information retrieved from a database or registry on the target vehicle resulting from a query based on the licence plate number value of the unique identifier value. For instance, a value for the colour of the target vehicle received from the wireless licence plate may be compared to a value for the colour of the target vehicle determined from the image of the scene. The value of the colour of the target vehicle received from the wireless licence plate and/or determined from the image of the target vehicle may be compared to a value of a colour of the target stored in a registry or database that may be queried using the unique identifier value or the licence plate number value. A mismatch between two or more of the received values from the wireless licence plate, the value determined from the image of the scene and the value queried from the registry or database may be identified and optionally recorded.

Other values that may be compared (between two or more of (1) the received values from the wireless licence plate, (2) the value determined from the image of the scene and (3) the value retrieved from the registry or database following a query of the registry or the database) include, but are not limited to, a model of the vehicle, a year of the vehicle, a type of vehicle, etc.

### Exemplary Method of Verifying an Absence of a Response for a Wireless Licence Plate:

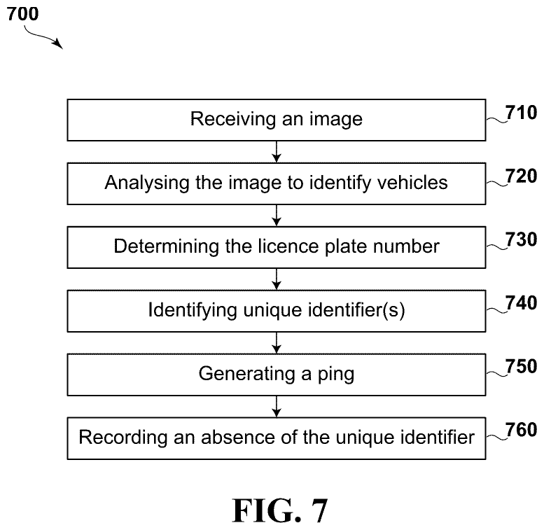

Reference is now made to FIG. 7, illustrating an exemplary method 700 of verifying an absence of a response for a wireless licence plate. The method 700 may be performed by system 100, any other system in accordance with the present teachings, or by a computing device in communication with a system in accordance with the present teachings such as system 100.

An image of a scene, captured by an image capture device, is received at step 710. The image capture device may be camera, such as a red-blue-green (RGB) camera. The image capture device may be a 360-degree camera. The camera may have a pan, tilt and/or zoom function.

The image may be a colour image. The image may be in grayscale. The image may be a 360-degree image.

The image may be that of a road, where the target vehicle may be located.

In some embodiments, a plurality of images, or a stream of images, may be received, where the plurality of images show a change in the scene over time.

The image of the scene is analyzed at step 720. In some embodiments, the analysis is performed to identify one or more objects in the image corresponding to vehicles, in the virtual space of the image.

Object recognition may be performed on the image to identify the object(s) present in the image that correspond to vehicle(s). For instance, the object recognition function may isolate and correlate in the image constellations of pixels or patterns corresponding to known traits of vehicles. The objects corresponding to vehicles are identified in the image (and may be defined through use of pixel coordinates, with x and y coordinates).

In instances where multiple images are received from an image capture device, object recognition may be performed on each of the images to identify object(s) corresponding to vehicles appearing in the each of the images.

A licence plate number for one or more of the vehicles objects appearing in the image of the scene is determined at step 730.

Further object recognition is performed on an identified object of a vehicle identified in the image of the scene to identify an object corresponding to a licence plate for that vehicle. For instance, an object recognition function may scan for certain pixel constellations or patterns (e.g. licence plate corners) appearing in the object of the target vehicle to identify the licence plate object. An analysis to determine the licence plate objects may be performed on some or all of the vehicle objects defined in the virtual space of the image of the scene.

Once the licence plate object has been identified in the image of the scene, optical character recognition may be performed on the licence plate number to determine the string of characters appearing in the licence plate object, corresponding to the licence plate number. Once identified, the licence plate number may be stored in memory.

In some embodiments, when a plurality of images is received from the image capture device, as the target vehicle may appear in different positions in each of the images, taken at a different time, an object of a licence plate may not be recognized in each of the images. Object recognition may be performed on each of the images to determine if a licence plate object is visible in each of the images. Exemplary vehicle tracking methods are described in U.S. Patent Number U.S. Pat. No. 10,990,830, incorporated herein by reference.

A query may then be generated for querying a registry stored locally or stored in an external database to search for a unique identifier that corresponds to the identified licence plate number at step 740. The query may be performed by parsing the characters of the licence plate number to identify a data structure stored in memory with a match for the characters of the licence plate number, corresponding to the target vehicle that has been attributed the licence plate number. A unique identifier may be retrieved from the data structure corresponding to the licence plate number.

The unique identifier for the target vehicle, and optionally other information on the target vehicle stored in the data structure corresponding to the licence plate, is received.

A listening for a reception of an electromagnetic wave carrying a unique identifier corresponding to the queried unique identifier is then performed. If the image of the scene identifying the target vehicle was captured contemporaneously, then the target vehicle, having a wireless licence plate, may be in wireless range of the antenna that is adapted to capture the electromagnetic wave with the unique identifier.

In some instances, an interrogation may be generated at step 750 and broadcast for causing a wireless licence plate to broadcast the unique identifier in response to the reception of the interrogation. In some embodiments when the wireless licence plate is continuously broadcasting the unique identifier to nearby recipient antennae, the generating of an interrogation may not be performed.

If a reception of an electromagnetic wave carrying a unique identifier corresponding to the queried unique identifier does not occur (e.g. over a period of time following the identification of the licence plate number in the image of the scene), then an absence of reception of the unique identifier may be recorded at step 760 (in local memory, transmitted and stored in memory of a remote database, transmitted for recordal in a remote server, etc.) A message or alert (e.g. an audio alert, a visual alert such as a generating of an icon on a screen, etc.) signaling the absence of a unique identifier when a unique identifier is expected to be received by the target vehicle, may be generated.

If an electromagnetic wave with a unique identifier corresponding to the queried unique identifier is received, then a confirmation of receipt of the unique identifier corresponding to the licence plate number identified in the image of the scene may also be recorded.

As such, method 700 may permit identifying a target vehicle from which a reception of a unique identifier, broadcast by a functional wireless licence plate, is expected, as the target vehicle is expected to possess a functional wireless licence plate. An absence of reception of the unique identifier from that target vehicle may be indicative that the licence plate for that target vehicle as been unlawfully replaced, the wireless licence plate for the target vehicle has been removed (e.g. in order to avoid law enforcement), etc.

Exemplary Method for Establishing a Presence of Wireless Communication with a Target Vehicle:

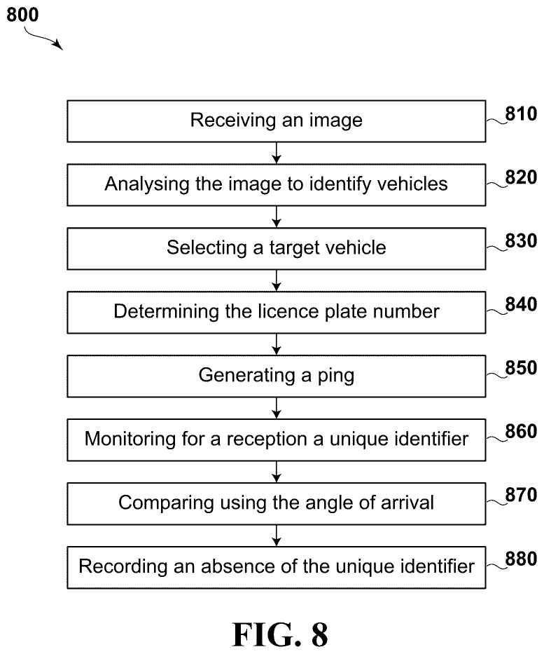

Reference is now made to FIG. 8, illustrating an exemplary method 800 for establishing a presence of wireless communication (via a wireless licence plate) with a target vehicle. The method may be performed by system 100, any other system in accordance with the present teachings, or by a computing device in communication with a system in accordance with the present teachings such as system 100.

An image of a scene, captured by an image capture device, is received at step 810. The image capture device may be a camera, such as a red-blue-green (RGB) camera. The image capture device may be a 360-degree camera. The camera may have a pan, tilt and/or zoom function.

The image may be a colour image. The image may be in grayscale. The image may be a 360-degree image.

The image may be that of a road, where the target vehicle may be located.

In some embodiments, a plurality of images, or a stream of images, may be received, where the plurality of images shows a change in the scene over time.

The image of the scene is analyzed at step 820. The analysis is performed to identify one or more objects in the image corresponding to vehicles, in the virtual space of the image.

Object recognition may be performed on the image to identify the object(s) present in the image that correspond to vehicle(s). For instance, the object recognition may isolate and correlate in the image constellations of pixels or patterns corresponding to known traits of vehicles. The objects corresponding to vehicles are identified in the image.

In instances where multiple images are received from an image capture device, object recognition may be performed on each of the images to identify object(s) corresponding to vehicles appearing in the each of the images.

One vehicle object of the identified vehicle objects defined in the image of the scene is selected at step 830.

A licence plate number of the vehicle corresponding to the selected vehicle object is determined at step 840.

Further object recognition is performed on the selected vehicle object identified in the image of the scene to identify an object corresponding to a licence plate for that vehicle. For instance, an object recognition function may scan for certain pixel constellations or patterns (e.g. licence plate corners) appearing in the object of the target vehicle to identify the licence plate object.

Once the licence plate object has been identified in the image of the scene, optical character recognition may be performed on the licence plate number to determine the string of characters appearing in the licence plate object, corresponding to the licence plate number. Once identified, the licence plate number may be stored in memory along with the unique identifier received from the wireless licence plate.

In some embodiments, when a plurality of images is received from the image capture device, as the target vehicle may appear in different positions in each of the images, taken at a different time, an object of a licence plate may not be recognized in each of the images, even though object recognition may be performed on each of the images to determine if a licence plate object is visible in each of the images.

In some instances, an interrogation may then be generated for nearby vehicles in the real world that are in range to receive the interrogation, for reception by their wireless licence plate, if present, at step 850. The interrogation is configured to cause the wireless licence plate receiving the interrogation to transmit an electromagnetic wave with the unique identifier of the wireless licence plate to the broadcaster of the interrogation.

In some instances, when the wireless protocol of the wireless licence plates is configured to cause a continuous broadcasting of the unique identifier for the wireless licence plate, the generating and transmitting of an interrogation may not be performed for causing the transmission of the electromagnetic wave with the unique identifier by the wireless licence plate.

Monitoring of a reception of an electromagnetic wave with a unique identifier is performed at step 860.

If no electromagnetic wave with a unique identifier is received (after a given period of time that may defined depending on the movement speed of the vehicles, e.g., determined by the speed limit for the road), an indication regarding an absence of unique identifier for the target vehicle with the identified licence plate number may be recorded (and stored in local memory or in memory of an external database).

When an electromagnetic wave with a unique identifier is received, travel information for the electromagnetic wave (e.g. an angle of arrival) may be determined using, e.g., information gathered by one or more antenna arrays receiving the electromagnetic wave with the unique identifier.

The travel information permits a determination of a location and/or direction of the origin of the wireless licence plate that generated the electromagnetic wave. For instance, the travel information may include, as an angle of arrival, an azimuth angle (an angle measured along a horizontal plane) and/or a zenith angle or altitude angel (an angle measured along a vertical plane). The angle or arrival may be defined by one or more vectors.

The travel information may include a distance value corresponding to a travel distance of the electromagnetic wave from the wireless licence plate emitting the electromagnetic wave to the antenna receiving the electromagnetic wave.

One or a plurality of antenna arrays may be used (e.g. located on the patrol vehicle, where each of the antenna arrays may be located at a different position on the patrol vehicle) to determine the travel information. Each of the antennas of the array of antennas may receive the signal transmitted by the wireless licence plate. The difference in reception time of the electromagnetic wave by each of the antennas of the antenna array, combined with known positions of the antennas of the antenna array with respect to one another, may be measured to derive the angle of arrival.

A distance of travel of the signal from the wireless licence plate to the antenna may be calculated following a use of two or more antenna arrays located, e.g., at different positions on the patrol vehicle. For instance, a time-by-flight sensor may be used to measure the distance to the vehicle with the wireless licence plate emitting the wireless signal. In some instances, a distance may be calculated using a plurality of image capture devices, generating simultaneously an image of the scene, where differences in the field of views and the positions of the image capture devices with respect to one another may be used to approximate the distance from the antenna (or the image capture devices) to the target vehicle.

The travel information may then be translated into the image space of the image of the scene received at step 810. The travel information of the electromagnetic wave carrying the unique identifier may be analyzed to convert the travel information into one or more vectors in the virtual space of the image corresponding to the travel information in real space.

An offset in time between the capturing of the image of the scene and the time of receipt (or transmission) of the electromagnetic wave sharing the unique identifier may also be factored when performing the conversion, where the offset in time may result in the patrol vehicle moving with respect to the target vehicle.

The generating of the one or more vectors from the travel information, resulting in a conversion or match of the travel information from real space to image space of the image of the scene, may also account for a difference in position of the image capture device that generated the image of the scene, with respect to the position of the one or more antennae that are the basis for the generating of the travel information (e.g. as the image capture device may be located on the patrol vehicle at a location that is different from the location of the one or more antennae).

The one or more vectors calculated from the travel information are applied to the image to identify, in the virtual space, which of the vehicle objects identified in step 820 corresponds to the vehicle that is the originator of the electromagnetic wave with the unique identifier. Determining a direction of arrival of the electromagnetic wave to the receiving antenna may be used to identify the location of the target vehicle from where the electromagnetic wave was transmitted, and an application of that travel information in the virtual space of the image of the scene enables the locating of the object of the target vehicle with the wireless licence plate that generated the electromagnetic wave in the virtual space of the image.

In some instances, the travel information, once converted to image space, may instead be applied to a new image generated by an image capture device, where steps 810 and 820 may be performed on the new images of the scene to identify the vehicle objects identified in the new image of the scene.

If a determination is made that the unique identifier has been received by the target vehicle identified at step 830, then an indication of the association between the target vehicle (e.g. via the licence plate number of the target vehicle identified at step 840) and the received unique identifier may be recorded and stored in memory (locally or at a remote database).

In some instances, the received unique identifier may instead be determined to originate from a different vehicle corresponding to a vehicle object defined in the image of the scene. In this situation, an association may instead be made between the vehicle corresponding to the identified vehicle object and the unique identifier, where this association may be recorded. A recordal of an absence of a wireless signal from the wireless licence plate of the target vehicle may also be performed and stored in memory (locally or at a remote database).

The generating of a response relating to and/or recording of an absence of a unique identifier received for the target vehicle may be performed and stored in memory (locally or at a remote database) at step 880 if:
no electromagnetic wave with a unique identifier is detected within a given period of time after the receiving an image of step 810 (this could signify an absence of an active wireless licence plate, for instance, due to the wireless licence plate being turned off, the battery or power source for the wireless licence plate being depleted, a malfunctioning of defective wireless licence plate, etc.); or
if the vehicle object identified in the image of the scene as the vehicle that originated the electromagnetic wave with the unique identifier does not have a unique identifier for the wireless licence plate that matches the licence plate number identified in the image of the scene, resulting in a mismatch between the received unique identifier and the recognized licence plate number in the image of the scene.

### Exemplary Method of Determining the Presence of a Wireless Licence Plate for a Target Vehicle:

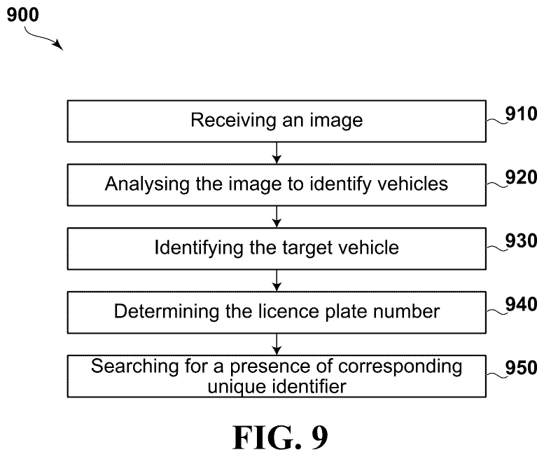

Reference is now made to FIG. 9, illustrating an exemplary method 900 of determining a presence of a wireless licence plate for a target vehicle. The method may be performed by system 100, any other system in accordance with the present teachings, or by a computing device in communication with a system in accordance with the present teachings such as system 100.

Method 900 may be performed when not all of the vehicles within a jurisdiction possess a wireless licence plate, where a determination of a presence of a wireless licence plate may be practical for obtaining more information that identifies the vehicle.

An image of a scene, captured by an image capture device, is received at step 910. The image capture device may be a camera, such as a red-blue-green (RGB) camera. The image capture device may be a 360-degree camera. The camera may have a pan, tilt and/or zoom function.

The image may be a colour image. The image may be in grayscale. The image may be a 360-degree image.

The image may be that of a road, where the target vehicle may be located.

In some embodiments, a plurality of images, or a stream of images, may be received, where the plurality of images shows a change in the scene over time.

The image of the scene is analyzed at step 920. The analysis is performed to identify one or more objects in the image corresponding to vehicles, in the image space of the image of the scene.

Object recognition may be performed on the image to identify the object(s) present in the image that correspond to vehicle(s). For instance, the object recognition may isolate and correlate in the image constellations of pixels or patterns corresponding to known traits of vehicles. The objects corresponding to vehicles are identified in the image.

In instances where multiple images are received from an image capture device, object recognition may be performed on each of the images to identify object(s) corresponding to vehicles appearing in the each of the images.

One vehicle object of the identified vehicle objects defined in the image of the scene is selected at step 930.

A licence plate number of the vehicle corresponding to the selected vehicle object is determined at step 940 by performing further object recognition.

Object recognition is performed on the selected vehicle object identified in the image of the scene to identify an object corresponding to a licence plate for that vehicle. For instance, an object recognition function may scan for certain pixel constellations or patterns (e.g. licence plate corners) appearing in the object of the target vehicle to identify the licence plate object.

Once the licence plate object has been identified in the image of the scene, optical character recognition may be performed on the licence plate number to determine the string of characters appearing in the licence plate object, corresponding to the licence plate number. Once identified, the licence plate number may be stored in memory along with the unique identifier received from the wireless licence plate.

In some embodiments, when a plurality of images is received from the image capture device, as the target vehicle may appear in different positions in each of the images, taken at a different time, an object of a licence plate may not be recognized in each of the images. Object recognition may be performed on each of the images to determine if a licence plate object is visible in each of the images.

A query may be generated based from the identified licence plate number to determine if the target vehicle associated to the licence plate number possesses a wireless licence plate at step 950.

The query may be transmitted to a stored repository (stored locally in memory or in an external database), where a search in the repository or database is performed based on the string of characters corresponding to the licence plate number of the transmitted query, to identify vehicle information associated to a licence plate number. For instance, information on a given vehicle may be stored as a data structure, where a licence plate number field of the data structure may be parsed and compared with the characters of the licence plate number that is part of the query.

The query may then cause a search in the data structure for a wireless licence plate number field, to determine a unique identifier defined in the wireless licence plate number field. If the data structure for the vehicle does not possess a licence plate number field, or if the licence plate number field is blank, the response to the query is that no wireless licence plate has been identified in association with the target vehicle.

If execution of the query results in a determination of a presence of a wireless licence plate for the target vehicle, then a response to a query may be a value indicative of a presence of a wireless licence plate (e.g. a string of characters: “present” “yes” “wireless licence plate found”) and/or a unique identifier of the wireless licence plate stored in the data structure for the target vehicle.

### Exemplary Image of a Scene:

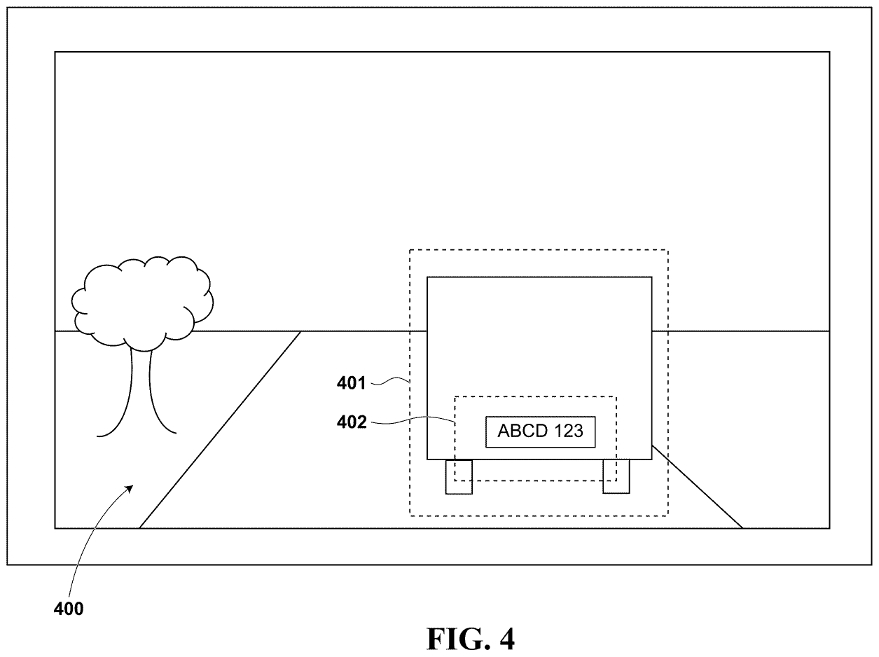

Reference is made to FIG. 4, illustrating an exemplary image of a scene 400 captured by an image capture device (e.g. a camera).

One or more image objects of vehicles 401 may be recognized in the image 400, the image object of the vehicle 401 defining a portion on the image (e.g. an arrangement of pixels in the image, e.g. defined by pixel coordinates, x and y, in the image) that represents a vehicle. Even though FIG. 4 only shows a single image object of a vehicle 401 for purposes of illustration, it will be understood that the image 400 may include a plurality of image objects of vehicles, depending on a number of vehicles captured in the image generated by the image capture device.

For an image object of a vehicle 401 appearing in the image 400, further object recognition may be performed on the portion of the image 400 defining the image object of the vehicle 401 to identify a licence plate object 402. The licence plate object 402 may also be defined using a series of pixel coordinates (e.g. x and y) in the image 400. The licence plate object 402 represents a portion of the image depicting a licence plate of the vehicle.

Character recognition may be performed on the licence plate object 402 to determine a licence plate number visible in the licence plate object 402.

The travel information generated from, e.g., the one or more antenna arrays, may be converted into vector(s) in the image space of the image 400. The vector(s) may cause an identification of the image object of the vehicle 401, thereby permitting an association between a unique identifier received from a wireless licence plate and an image object of the vehicle that is associated to the wireless licence plate that broadcast the unique identifier.

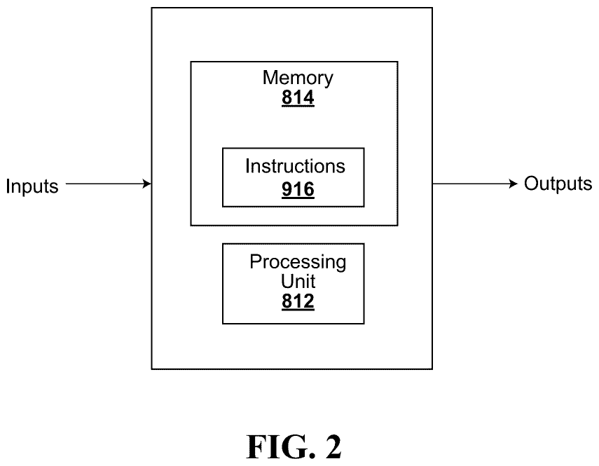

With reference to FIG. 2, the methods of the present disclosure may be implemented by one or more computing devices, such as a computing device 810 comprising a processing unit 812 and a memory 814 which has stored therein computer-executable instructions 916. Each of the server system 106 and the client computing device 110 may each be implemented by and/or comprise at least one computing device, such as the computing device 810.

The processing unit 812 may comprise any suitable devices configured to implement the methods such that instructions 916, when executed by the computing device 110 or other as described herein to be executed. The processing unit 812 may comprise, for example, any type of general-purpose microprocessor or microcontroller, a digital signal processing (DSP) processor, a central processing unit (CPU), a graphical processing unit (GPU), an integrated circuit, a field programmable gate array (FPGA), a reconfigurable processor, other suitably programmed or programmable logic circuits, or any combination thereof. The processing unit 712 may be referred to as a “processor”.

The memory 814 may comprise any suitable known or other machine-readable storage medium. The memory 814 may comprise non-transitory computer readable storage medium, for example, but not limited to, an electronic, magnetic, optical, electromagnetic, infrared, or semiconductor system, apparatus, or device, or any suitable combination of the foregoing. The memory 814 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 814 may include any storage means (e.g., devices) suitable for retrievably storing machine-readable instructions 916 executable by processing unit 812.

The methods and systems described herein may be implemented in a high-level procedural or object-oriented programming or scripting language, or a combination thereof, to communicate with or assist in the operation of a computer system, for example the computing device 810. Alternatively, the methods and systems described herein may be implemented in assembly or machine language. The language may be a compiled or interpreted language. Program code for implementing the methods and systems described herein may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems described herein may also be considered to be implemented by way of a non-transitory computer-readable storage medium having a computer program stored thereon. The computer program may comprise computer-readable instructions which cause a computer, or in some embodiments the processing unit 812 of the computing device 810, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

Although the invention has been described with reference to preferred embodiments, it is to be understood that modifications may be resorted to as will be apparent to those skilled in the art. Such modifications and variations are to be considered within the purview and scope of the present invention.

Representative, non-limiting examples of the present invention were described above in detail with reference to the attached drawing. This detailed description is merely intended to teach a person of skill in the art further details for practicing preferred aspects of the present teachings and is not intended to limit the scope of the invention. Furthermore, each of the additional features and teachings disclosed above and below may be utilized separately or in conjunction with other features and teachings.

Moreover, combinations of features and steps disclosed in the above detailed description, as well as in the experimental examples, may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

What is claimed is:

1. A method of identifying, in an image of a scene, a target vehicle that includes a wireless license plate transmitting a unique identifier for the target vehicle via an electromagnetic wave signal generated by the wireless licence plate and received at an antenna system, comprising:
determining an angle of arrival of the electromagnetic wave signal;
receiving from an image capture device the image of the scene comprising the target vehicle;
detecting a plurality of vehicles in the image of the scene; and
identifying one of the plurality of vehicles as the target vehicle on the basis of the angle of arrival of the electromagnetic wave signal.

2. The method according to claim 1, wherein the angle of arrival includes an azimuth angle and an altitude angle.

3. The method according to claim 1, where the unique identifier is received and the image of the scene is generated at a same time.

4. The method according to claim 1, further comprising:
calculating a difference in time between a time of reception of the electromagnetic wave signal delivering the unique identifier and a time of reception of the image of the scene; and
computing a change in position of the vehicle as a function of the difference in time that is factored when performing the identifying of the one of the plurality of vehicles as the target vehicle on the basis of the angle of arrival of the electromagnetic wave signal.

5. The method according to claim 1, wherein the image of the scene is a colour image.

6. The method according to claim 1, wherein the angle of arrival is determined from readings generated by two or more antenna arrays.

7. The method according to claim 1, further comprising determining a travel distance of the electromagnetic wave signal from a position of the target vehicle when the electromagnetic wave signal is generated, and wherein the identifying one of the plurality of vehicles as the target vehicle is further performed on the basis of the determined travel distance.

8. The method according to claim 1, wherein the image capture device is part of an array of image capture devices, and wherein the receiving, the detecting and the identifying is performed for more than one image capture device of the array of image capture devices.

9. The method according to claim 1, wherein the image capture device is a 360-degree camera.

10. The method according to claim 1, wherein the image of the scene is a depth image.

11. The method according to claim 1, further comprising generating and transmitting an interrogation to the wireless licence plate of the target vehicle to receive the unique identifier.

12. The method according to claim 1, wherein the unique identifier is a licence plate number.

13. The method according to claim 1, wherein the image of the scene includes virtual images of the target vehicle and one or more noise vehicles, wherein the identifying further comprises performing image analysis of the image of the scene using the angle of arrival to identify an object of the target vehicle in the image of the scene and distinguish the object of the target vehicle from the respective object or objects of the one or more noise vehicles appearing in the image of the scene.

14. The method according to claim 1, further comprising extracting from the image of the scene a licence plate number of the one of the plurality of vehicles as the target vehicle.

15. The method according to claim 14, further comprising comparing the extracted licence plate number to the unique identifier to determine a correspondence between the extracted licence plate number and the unique identifier.

16. A system for identifying, in an image of a scene, a target vehicle that includes a wireless license plate transmitting a unique identifier for the target vehicle via an electromagnetic wave signal generated by the wireless licence plate and received at an antenna system, comprising:
a processor; and
memory storing program code that, when executed by the processor, causes the processor to:
determine an angle of arrival of the electromagnetic wave signal;
receive from an image capture device the image of the scene comprising the target vehicle;
detect a plurality of vehicles in the image of the scene; and
identify one of the plurality of vehicles as the target vehicle on the basis of the angle of arrival of the electromagnetic wave signal.

17. The system according to claim 16, wherein the angle of arrival includes an azimuth angle and altitude angle.

18. The system according to claim 16, wherein the program code further causes the processor to:
calculate a difference in time between a time of transmission or of generation of the electromagnetic wave signal delivering the unique identifier and a time of generation or of reception of the image of the scene; and
compute a change in position of the vehicle as a function of the difference in time that is factored when performing the identifying of the one of the plurality of vehicles as the target vehicle on the basis of the angle of arrival of the electromagnetic wave signal.

19. The system according to claim 16, wherein the image of the scene includes virtual images of the target vehicle and one or more noise vehicles, wherein the identifying further comprises performing image analysis of the image of the scene using the angle of arrival to identify an object of the target vehicle in the image of the scene and distinguish the object of the target vehicle from the respective object or objects of the one or more noise vehicles appearing in the image of the scene.

20. A non-transitory computer-readable medium having stored thereon program instructions for identifying, in an image of a scene, a target vehicle that includes a wireless license plate transmitting a unique identifier for the target vehicle via an electromagnetic wave signal generated by the wireless licence plate and received at an antenna system, the program instructions executable by a processing unit for:
determining an angle of arrival of the electromagnetic wave signal;
receiving from an image capture device the image of the scene comprising the target vehicle;
detecting a plurality of vehicles in the image of the scene; and
identifying one of the plurality of vehicles as the target vehicle on the basis of the angle of arrival of the electromagnetic wave signal.
